(19) United States
(12) Patent Application Publication
(10) Pub. No.: US 2021/0374199 A1
(43) Pub. Date: Dec. 2, 2021

(54) A DATA COMMUNICATION SYSTEM AND METHOD FOR USE OF THE DATA COMMUNICATION SYSTEM

(71) Applicant: Augmania Inc., San Francisco, CA (US)

(72) Inventor: Rania REDA, Alexandria (EG)

(21) Appl. No.: 16/965,581

(22) PCT Filed: Jan. 27, 2019
(86) PCT No.: PCT/IB2019/050650

§ 371 Date: Jul. 28, 2020

(30) Foreign Application Priority Data
Jan. 28, 2018 (IB) PCT/IB2018/050508

(51) Int. Cl. G06F 16/958; G06F 16/9535; G06T 19/00

(52) U.S. Cl. CPC G06F 16/958; G06T 19/006; G06F 16/9535

(57) ABSTRACT

Disclosed is a data communication system for creating and/or experiencing an internet-based augmented reality content which includes a creator data communication device to be used by a creator, and a user data communication device to be used by a user and an internet-based data processing device and, a method for creating an internet-based augmented reality content using the inventive data communication system, and a method for experiencing an internet-based augmented reality content using the inventive data communication system.

### FIELD OF THE INVENTION

The invention relates to a data communication system for creating and/or experiencing an internet-based augmented reality content comprising a creator data communication device to be used by a creator, a user data communication device to be used by a user and an internet-based data processing device, a method for creating an internet-based augmented reality content using the inventive data communication system, and a method for experiencing an internet-based augmented reality content using the inventive data communication system.

### BACKGROUND

Augmented Reality (AR) technique generally refers to altering a view of reality by computer-generated or extracted real-world sensory input such as visual, audio, haptic or geolocation data.

Thus, by use of the AR technology the real world becomes interactive and digitally alterable, as information is so called “overlaid” on the real world.

The field of possible applications of AR technology is immense and covers application, e.g., in the field of literature, archaeology, architecture, visual art, commerce, education, emergency management/search and rescue, video games, industrial design, medical applications, spatial immersion and interaction, flight training, military applications, navigation, workplace management, broadcasting, live events, tourism and sightseeing, translation, music, and retail.

Presently, AR applications such as Aurasma, Blippar or Augment are on the market for providing AR contents, wherein software relating to the AR application has to be downloaded and installed on the data communication device of a user, who wants to experience such an AR experience. The creating of the present AR applications requires detailed understanding of the technique, as e.g. for different types of user data communication devices (such as based on android or OS, or having different sizes of displays) the applications have to be designed separately. In other words, specialized service providers have to be contacted to create the AR application for respective user data communication devices, which is time and cost consuming.

Furthermore, the download of the AR application onto the user data communication device may be an obstacle to some potential users, so that the AR content may not be experiencable by certain potentially relevant users.

Moreover, the download of the AR application onto the user data communication device does not enable the creator of the AR application to retrieve deep analytic information about the user experience of the AR application. In other words, while the download of the AR application by the user may tell the creator how often the AR application has been downloaded, no information on the number of executions of the augmented reality content, the duration of the user experience, the conducted steps, etc. can be used by the creator. This means, that the creator cannot learn from the user experience whether and how to adapt/edit a present or a future AR content to achieve a better user experience and, thus, a better performance.

Hence, the present invention aims to provide a data communication system and a method for data communication for creating and/or experiencing augmented reality contents, wherein i) the creating of the AR content is improved, preferably, wherein the AR content has not to be designed differently for different user data communication devices, and/or ii) user experience information of an AR content is available to the creator.

### SUMMARY

The aims of the invention are solved by the invention as presented in the independent claims. Preferred embodiments are provided in the dependent claims as well as in the description and figures as further aspects of the invention.

The present invention provides an internet-based platform for creating and/or experiencing an internet-based augmented reality content. Also included within the scope of this invention is a data communication system and methods and uses for creating and/or experiencing the internet-based augmented reality content. The inventive data communication system for creating and/or experiencing an internet-based augmented reality content comprises a creator data communication device to be used by a creator, a user data communication device to be used by a user and an internet-based data processing device. The internet-based augmented reality content may in general alter the visual information of reality, and/or the audio information of reality, and/or the haptic information of reality and/or the geological position information of reality.

According to a first embodiment of the invention a data communication system for creating and/or experiencing an internet-based augmented reality content comprising a creator data communication device to be used by a creator, a user data communication device to be used by a user and an internet-based data processing device is provided in accordance with claim 1.

Furthermore, as the creator, e.g., marketer, can create the content himself, he may also edit the AR content as needed, e.g. on an event, conference or other live act. In this case, the user does not have to download an edited AR application to experience the edited AR content.

By creating and/or experiencing an augmented reality (AR) content via the internet, the design of the AR content is improved, as it is not necessary any longer to design separate AR contents for different user data communication devices. In other words, the present invention enables a creator, such as a business company, e.g. a marketer, or a brand name company or else, to create an AR content on an internet-based data processing device, in particular an internet-based network, such as a cloud network, and to disseminate the AR content via internet addresses, e.g. URL links, to potential users. This means the internet-based AR content is pushed to the user through the cloud and can be experienced by the user independent of the user operating system. In turn this eliminates the need to program different AR applications suitable for different end user devices, which in addition would have to be actively downloaded by the user prior to experiencing an AR content. In addition, AR applications are also subject to third party approval in App-Stores, which either leads to a time delay prior to publishing the AR content or which may also result in a refusal for publishing the AR application at all. Furthermore, as the internet-based AR content and the data sets for creating an AR content are accessible by the creator on the internet-based network, such as a cloud network, the creator can perform management operations, update or editing operations, and maintenance operations directly on the internet-based data processing device, such as an internet-based network, e.g. the cloud. For example the creator may use one or more of the data sets for further creations of AR contents without the need of uploading the data sets again. In addition, creating the AR content on the internet-based network, such as a cloud network, allows the creator to amend or edit the AR content on the internet-based network. Thus, when accessing the internet address, the user readily experiences the updated AR content without the need of downloading an updated AR application to its user data communication device. Thus, the present invention reduces time spent for creating and/or updating an AR content. Furthermore, the internet-based AR content may easily be shared with potential users by the internet, as the internet address can be accessed, e.g. by the users browser, so that the present invention may also attract those users, who would otherwise not download an AR application to their user data communication device to experience the AR content. Moreover, experiencing the AR content via the internet allows logging deep analytic information about the user experience of the AR content and providing the same to the creator, who then can improve/edit the same or further AR contents accordingly. In summary, the present invention
reduces time and therefore costs for creating AR content,
enables maintenance and updates of an AR content by the creator without the need of programming new internet applications, which would have to be actively downloaded by the user in order to experience the updated AR content,
enables users to experience AR content, in particular the most updated version of an AR content, regardless of their end device and without the need of actively downloading a software application or login into a software application already installed on the end device, the only requirement is, that the end device may access the internet and, thus, may access the internet address, in particular the URL link assigned to the AR content, and
enables in a preferred embodiment the creator to learn from the users' experience of the internet-based AR content by being able to log deep analytic information about the user experience of the AR content and providing the same to the creator, who then can improve/edit the same or further AR contents accordingly.

The creator data communication device comprises an internet access unit with an application programming interface (API) for the internet-based data processing device, a display unit for displaying information, a processing unit comprising one or more processors, and an input unit for inputting a data set A for creating the internet-based augmented reality content. The data set A optionally comprises a creator find data set A1 and comprises an augmented reality show data set A2. The creator data communication device—which when executed by at least one processor—is configured to send or to provide access to the data set A to the internet-based data processing device.

The user data communication device comprises an internet access unit with an application programming interface (API) for the internet-based data processing device, a display unit for displaying information, one or more sensor units, and a processing unit comprising one or more processors. The user data communication device—which when executed by at least one processor—is configured to send or to provide access to a sensor data set B obtained from the one or more sensor units to the internet-based data processing device and to retrieve the augmented reality show data set A2 from the internet-based data processing device for experiencing the internet-based augmented reality content on the user data communication device.

The internet-based data processing device comprises a content creating unit, a logic unit and a processing unit comprising one or more processors. The internet-based data processing device—which when executed by at least one processor—is configured to store the data set A and create the internet-based augmented reality content in the content creating unit. The content creating unit is configured to assign an internet address, preferably a URL address, to the internet-based augmented reality content and to send or to provide access to the assigned internet address to the creator data communication device and/or to make publicly available the assigned internet address. The internet-based data processing device—which when executed by at least one processor—is configured to compare the sensor data set B received or accessed from the user data communication device with the creator find data set A1 for a predetermined degree of conformity. The internet-based data processing device—which when executed by at least one processor—is configured to send or to provide access to the augmented reality show data set A2 to the user data communication device in case the sensor data set B and the creator find data set A1 match.

According to a second embodiment of the invention a method for creating an internet-based augmented reality content using the inventive data communication system is provided. The inventive method comprises or consists of the following steps:

Providing an internet-based data processing device comprising a content creating unit, a logic unit and a processing unit comprising one or more processors.

Providing a creator data communication device comprising an internet access unit with an application programming interface (API) for the internet-based data processing device, a display unit for displaying information, a processing unit comprising one or more processors, and an input unit for inputting a data set A for creating the internet-based augmented reality content. The data set A comprises a creator find data set A1 and an augmented reality show data set A2. Alternatively, the data set A does not comprise a creator find data set A1, but it comprises an augmented reality show data set A2. This means, that the augmented reality content of the present invention does not need a trigger to be displayed on the user data communication device. As an example, the user accesses through the user data communication device the internet address of the internet-based augmented reality content and without a trigger the augmented reality content is pushed through the internet-based data processing device, preferably an internet-based network, more preferably a cloud network to the user data communication device in order to be experiencable by the user. Accessing the internet-based data processing device with the creator data communication device.

Sending or providing access to the data set A optionally comprising the creator find data set A1 and comprising the augmented reality show data set A2 from the creator data communication device to the internet-based data processing device.

Creating the internet-based augmented reality content with the content creating unit.

Assigning an internet address, preferably a URL address for the internet-based augmented reality content by the internet-based data communication device and sending or providing access to the assigned internet address of the internet-based augmented reality content to the creator data communication device and/or making publicly available the assigned internet address of the internet-based augmented reality content.

According to a third embodiment of the invention a method for experiencing an internet-based augmented reality content using the inventive data communication system is provided. The inventive method comprises or consists of the following steps:

Step a): Providing an internet-based data processing device comprising a content creating unit and a stored internet-based augmented reality content comprising a data set A with optionally a creator find data set A1 and with an augmented reality show data set A2, a logic unit and a processing unit comprising one or more processors.

Step b): Assigning an internet address, preferably a URL address, to the stored internet-based augmented reality content of step a).

Step c): Providing a user data communication device comprising an internet access unit with an application programming interface (API) for the internet-based data processing device, a display unit for displaying information, one or more sensor units, and a processing unit comprising one or more processors, and accessing the internet-based data processing device by use of the assigned internet address of step b).

Step d): Optionally recording a sensor data set B with the one or more sensor units and sending or providing access to the sensor data set B to the internet-based data processing device.

Step e): Comparing the sensor data set B with the creator find data set A1 for a predetermined degree of conformity by use of the logic unit and sending or providing access to the augmented reality show data set A2 from the internet-based data processing device to the user data communication device in case the sensor data set B and the creator find data set A1 match.

Alternatively, in case the internet-based AR content does not require the comparison of a creator find data set A1 with a sensor data set B, the augmented reality show data set A2 is sent or provided to the user data communication device after accessing the internet-based data processing device according to step c).

Step f): Experiencing the internet-based augmented reality content on the user data communication device by adding the augmented reality show data set A2 to a reality data set C recorded by one or more of the sensor units and displaying the combination thereof.

According to a fourth embodiment of the invention the inventive data communication system is used for creating and/or experiencing an internet-based augmented reality content.

The present invention is set out in more detail including preferred and/or alternative aspects in the following description, the dependent claims and the drawing. The features of the present inventive embodiments as set out above may be combined in any (sub-)combination and may also be combined with features or (sub-combination) of features of the detailed description, dependent claims and/or drawing, as long as the resulting feature combination is reasonable for a person skilled in the art.

Embodiments described in the context of one of the inventive methods or devices and systems are analogously valid for the other methods or devices. Similarly, embodiments described in the context of an inventive method are analogously valid for an inventive device, and vice versa.

Features that are described in the context of an inventive embodiment may correspondingly be applicable to the same or similar features in the other embodiments. Features that are described in the context of an inventive embodiment may correspondingly be applicable to the other embodiments, even if not explicitly described in these other embodiments. Furthermore, additions and/or combinations and/or alternatives as described for a feature in the context of an inventive embodiment may correspondingly be applicable to the same or similar feature in the other embodiments.

### BRIEF DESCRIPTION OF DRAWINGS

Further features and advantages of the invention will become apparent from the following description and from the accompanying drawings to which reference is made. In the drawing:

FIG. 1 shows a schematic overview of the system according to the invention

TABLE OF REFERENCE NUMBERALS
The reference signs used in the present application are the following:

| | |
|---|---|
| 1 | data communication system for creating and/or experiencing an |
| | internet-based augmented reality content |
| 10 | creator data communication device to be used by a creator |
| 101 | internet access unit with an application programming interface |
| | (API) for the internet-based data processing device 12 |
| 102 | display unit for displaying information |
| 103 | processing unit comprising one or more processors |
| 104 | input unit |
| A | data set for creating the internet-based augmented reality content |
| A1 | creator find data set |
| A2 | augmented reality show data set |
| 11 | user data communication device to be used by a user |
| 111 | internet access unit with an application programming interface |
| | (API) for the internet-based data processing device 12 |
| 112 | display unit for displaying information |
| 113 | one or more sensor units |
| 1131 | optical sensor unit |
| 1132 | audio sensor unit |
| 1133 | geolocation sensor unit |
| 1134 | haptic sensor unit |
| 114 | processing unit comprising one or more processors |
| B | sensor data set |
| C | reality data set |
| 12 | internet-based data processing device |
| 121 | content creating unit |
| 122 | logic unit |
| 123 | processing unit comprising one or more processors |
| 124 | user tracking unit |
| 125 | content analytics unit |
| 126 | deep learning unit |
| A11 | one or more find data images |
| A111 | one or more corresponding find data images |
| A1* | creator find data set comprising assigned one or more |
| | corresponding find data images A111 |
| 127 | artificial intelligence unit |
| 128 | augmented reality interaction unit |
| 129 | previewing unit |
| B* | simulation sensor data set |
| C* | simulation reality data set |
| 1210 | tutorial unit |

### DETAILED DESCRIPTION OF INVENTION

The present invention is directed to providing an internet-based platform for creating and/or experiencing an internet-based augmented reality content. Also included within the scope of this invention is a data communication system and methods and uses for creating and/or experiencing the internet-based augmented reality content.

In the context of the present invention, the articles “a”, “an” and “the” as used with regard to a feature or element include a reference to one or more of the features or elements.

In the context of the present invention, the phrase “at least substantially” may include “exactly” and a reasonable variance.

In the context of the present invention, the term “about” as applied to a numeric value encompasses the exact value and a reasonable variance.

As used in the context of the present invention, the term “and/or” includes any and all combinations of one or more of the associated listed items.

As used in the context of the present invention, the phrase of the form of “at least one of A or B” may include A or B or both A and B. Correspondingly, the phrase of the form of “at least one of A or B or C”, or including further listed items, may include any and all combinations of one or more of the associated listed items.

The term “internet-based augmented reality content” is in the context of the present invention synonymously used with the terms “augmented reality content”, “AR content” and “content”. The term “internet-based augmented reality content” means that an augmented reality information (augmented reality show data set A2) is combined with information about reality and accordingly, the information about reality is altered. Such an internet-based augmented reality content may be used in form of a campaign for advertising or other information purposes. Alternatively, the internet-based augmented reality content may be used in the industrial field of art, e.g. literature, visual art, industrial design, sound and music, commerce, retail, education, emergency management/search and rescue, video games, medical applications in particular for scientists, physicians and/or patients, spatial immersion and interaction, flight training, military applications, navigation, workplace management, broadcasting, live events, tourism and sightseeing, translation, maintenance and/or repair services for products or buildings, product operation, and mail delivery. As an example, the augmented reality information may be represented by an image of a “red rose”. This image of the “red rose” would then be combined with visual information of part of the reality taken by a camera of the user device, such as an image or an image sequence (video) of a “desk”. The user may experience the internet-based augmented reality content as an image or image sequence wherein the “red rose” is placed on the “desk”. The internet-based augmented reality content, in particular internet-based augmented reality campaign may comprise one or more steps, which can be executed by the user and may further comprise one or more links or hyperlinks or other means (so called “call to action”), which can be activated by the user experiencing, in particular viewing the internet-based augmented reality content, in particular internet-based augmented reality campaign. The user also may refer other potential users to experience, in particular view, the internet-based augmented reality content, in particular internet-based augmented reality campaign.

In case the inventive data communication system, in particular the creator data communication device, the user data communication device, the internet-based data processing device or any unit installed thereon is configured to operate in a certain way, the configuration is generally conducted by using or providing access to a suitable algorithm, such as an algorithm for a software application, for the respective device and/or unit. In other words, a respective device and/or unit of the inventive data communication system, which is configured to operate in a certain way comprises one or more preprogrammed command modules which execute the respective operations/function. The use of the inventive system including the configured units thus has the advantage, that a creator does not have to be acquainted in programming augmented reality content, such as necessary in prior art augmented reality content applications, which have first to be programmed for specific operation systems and devices and subsequently have to be actively downloaded and installed by the user to the user data communication device as a software application.

In general, the present invention enables the creator to create an augmented reality content by use of the inventive data communication system as follows. The creator may access the internet-based data processing device with a suitable user data communication device which can access the internet, e.g. with a certain browser such as internet explorer, Firefox, etc. The access is typically performed by using a predefined internet address which directs the user data communication device to the internet-based data processing device of the present invention, which in particular comprises the content creating unit, the logic unit and a processing unit comprising one or more processors. In order to safe-guard its own augmented reality contents (synonymously be called augmented reality campaigns) the creator may be asked after accessing the predefined internet-address to open or to log into an account, which may be protected by a user name and password. As described above the content creating unit, the logic unit and the processing unit are configured by suitable algorithms for software application, in other words comprise preprogrammed command modules.

For starting a creation of a new augmented reality content (new augmented reality campaign), the creator may execute the preprogrammed command modules of the inventive data communication system, in particular the content creating unit, by selecting a data set comprising a find information data set, which later triggers executing the augmented reality content on the user data communication device, and comprising an augmented reality show data set to be overlaid on the reality and thereby augmenting the reality. In other words, by selecting the find information data set and the augmented reality show data set(s) by the creator, the algorithms of the content creating unit are executed to create the internet-based augmented reality content. Thereby the find information data set corresponds to one or more augmented reality show data sets. Furthermore, the content creating unit is configured, i.e. preprogrammed, to assign to the newly created augmented reality content an internet address, e.g. a URL link. The URL link is accessible through the creator data communication device or any other third party data communication device provided the device is internet-accessible, such as a user data communication device. The assigned internet address of the augmented reality content is typically a URL link to the inventive internet-based data processing device (e.g., www.augmania.co/ . . . , in particular www.augmania.co/redrose). Alternatively, the creator may select to mask the assigned internet address (e.g., www.augmania.co/ . . . , in particular www.augmania.co/redrose) by providing a so called “white labeled” internet address (e.g. www.redrose.com/AR). In the latter case the white labeled internet address, e.g. URL link is redirected, e.g. by DNS, to the assigned internet address of the augmented reality content (augmented reality campaign).

The find information data set may be a creator find data set to be selected by the creator or may alternatively be no information, which means that no trigger is necessary to execute sending/providing access to the augmented reality content on the user data communication device. The creator find data set may preferably be selected from the group consisting of an optical information, preferably an alphanumeric information, a code information, such as a bar code or a Quick Read (QR) code, and an image, preferably an image view of a portion of reality or an image of a face, an audio information, a geolocation information and a haptic information. The optical information may in particular be provided in form of a data file extension jpg, png, jpeg. The geolocation information may be selected by providing the geolocation information, in particular by typing the address into a command field or by pinning the address on a map provided by the content creating unit. In case the creator find data set is a code, in particular a bar code or a QR code, the code is either provided by the creator or the creator selects that the content creating unit creates the respective code. In the latter case, the creator may e.g. type into a respective field a specific name, such as “redrose find data 1” and the content creating unit converts with the preprogrammed command module this specific name into a code, such as a bar code or QR code. The creator may provide a respective creator find data set by uploading a data file or by providing a link to an internet accessible data base, such as flickr® for images, YouTube® for videos and music, SoundCloud® for audio files. Alternatively, the creator may select a respective file of a predefined creator find data set library comprising one or more creator find data sets stored on or accessed by the internet-based data processing unit.

In case the find information data set relates to a creator find data set as set out above, the performance of the augmented reality content on the user data communication device first requires a comparison of data, namely the creator find data and a sensor data set B provided by the user data communication device. The logic unit is configured to compare the creator find data set with a sensor data set B to be provided or accessed by the user data communication device to the internet-based data processing unit. This means, that the logic unit performs the comparison by executing the preprogrammed command modules and compares the data sets for a predetermined degree of conformity (matching requirement). Suitable predetermined degrees of conformity for comparison the data sets are already available in the prior art, such as minimum feature identity for comparison of optical information, such as images or optical codes, and predefined or adjustable default range with respect to geolocation. In case the logic unit determines that the sensor data set fulfills the predetermined degree of conformity and, thus, matches with the creator find data set, the content creating unit is preprogrammed to execute sending or providing access of the augmented reality show data set to the user data communication device.

Alternatively, in case the find information data set is selected by the creator to be no information, then the content creating unit is configured, i.e. preprogrammed, to not perform a comparison of a creator find data set with a sensor data set and to execute sending or providing access of the augmented reality show data set to the user data communication device after accessing the assigned internet address by the user data communication device.

The find information data set, i.e. the creator find data set or no information, generally corresponds to one or more augmented reality show data sets.

In general the augmented reality show data set is any information suitable for augmenting the reality. According to a preferred embodiment, the augmented reality show data set is selected from the group consisting of an optical information, preferably an image, a video, a three dimensional (3D) image, text information, html5 information, e.g. in form of a web page, a game, and a survey, and a two or a three dimensional (3D) animation, an audio information, and/or a haptic information. Preferably the augmented reality show data set is selected from the group consisting of an image (e.g. data file extension jpg, png, jpeg), a 360° image (e.g. data file extension jpg, png, jpeg), a video (data file extension e.g. mp4, mov, mkv), a 360° video (e.g. data file extension mp4, mov, mkv), a three dimensional (3D) image (e.g. data file extension gif, jason, obj, fbx), a text information, htm15 information, e.g. in form of a web page, a game, and a survey, and a two or a three dimensional (3D) animation (e.g. data file extension gif, jason, obj, fbx), and/or an audio information (e.g. data file extension mp3). The creator may provide respective augmented reality show data sets by uploading one or more files or by providing a link to an internet accessible data base, such as flickr® for images, YouTube® for videos or music, SoundCloud® for audio files. Alternatively, the creator may select a respective file of a predefined augmented reality show data set library comprising one or more augmented reality show data sets stored on or accessed by the internet-based data processing unit. The creator may in a preferred embodiment select when the selected augmented reality show data set should be sent to or should be displayed on the user data communication device. This embodiment is in particular advantageous in case more than one augmented show data sets are selected to correspond to one find information data set. In case optical information is provided as an augmented reality show data set, the creator may predefine the location and/or the time of appearance of the one or more selected augmented reality show data sets on the display of the user data communication device. In case audio information is provided as an augmented reality show data set, the creator may predefine the time of appearance of the one or more selected augmented reality data sets on the user data communication device.

An internet augmented reality content may generally comprise one or more find information data sets and one or more show information data sets. In case it comprises one find information data set, i.e. creator find data set or alternatively no information, this find information data set corresponds to one or more augmented reality show data sets.

In an alternative embodiment, the augmented reality content comprises two or more find information data sets, i.e. no information and creator find data set(s) or different creator find data sets, the respective find information data sets may independently from each other correspond to one or more augmented reality show data sets. In this case the creator is required to select a preprogrammed command of the content creating unit whether the different combinations of find information data sets and corresponding augmented reality show data sets shall be performed in a sequential or random order. For example, in case certain pictures at an art exhibition, in particular in a gallery or museum, represent different find information data sets corresponding to one or more augmented reality show data sets respectively, the creator may preferably choose to select randomly performance of the augmented reality content. This selection enables the user to experience the augmented reality content corresponding to the separate pictures in his own order. Alternatively, in particular for educational purposes experiencing of an augmented reality content in a sequential order may be beneficial in order to increase knowledge building. For gamified or experiential augmented reality content experiences of a user, such as a treasure hunt, team building processes, consumer engagement experiences the augmented reality content may comprise the different combinations of find information data sets with augmented reality show data sets dependent on the aim in a sequential or in a random order.

In another alternatively or cumulatively preferred embodiment, the creator may provide or select additional data sets for creating the internet-based augmented reality content, such as information on further steps of the internet-based augmented reality content (e.g., “go to next step”, “go to previous step”, “save”) or on interaction steps with the user (e.g., so called “call to action” links/hyperlinks, such as “subscribe now”, “follow us”, “follow us on [ . . . ]”, “like us”, and “coupon”). In case the additional data sets are provided or selected by the creator, the content creating unit is configured, i.e. preprogrammed, to execute sending the additional data sets to the user data communication device. In a preferred embodiment, the creator may select when and/or where the selected additional data sets should be sent to the user data communication device. In case optical information is provided as an additional data set, the creator may predefine the location and/or the time of the appearance of the—and in case of multiple additional data sets of each—selected additional data set on the display of the user data communication device. In case audio information is provided as an additional data set, the creator may predefine the time of appearance of the—and in case of multiple additional data sets of each—selected additional data set on the user data communication device.

According to a further preferred alternative or cumulative embodiment of the present invention, the creator may select a template augmented reality content preprogrammed on the content creating unit of the internet-based data processing unit, preferably the internet-based network, such as the cloud. This template comprises one or more find information data sets and one or more augmented reality show data sets. This means, the creator does not have to upload or provide access to respective find information data sets and augmented reality show data sets. Instead the creator selects a preprogrammed template of an augmented reality content preferably from a library comprising one or more templates of preprogrammed augmented reality contents stored on the internet-based data communication device, preferably internet-based network, e.g. cloud. Upon selection, the content creating unit is configured, i.e. preprogrammed to assign to the augmented reality content template a corresponding internet address, which may be masked by the creator as set out above. In order to personalize the selected augmented reality content template for creator purposes, the creator may select brand names and/or user interaction steps, such as “call to action” links, hyperlinks, as additional data sets.

In a preferred embodiment the content creating unit visualizes the creation steps of the augmented reality content on the display of the creator data communication device, in particular as a visualized story board, preferably comprising one or more buttons comprising information about a step to be conducted and/or the selection to be taken, one or more text fields into which the creator may enter text information, such as a name of the augmented reality content, a “white labeled” internet address to be assigned to the created augmented reality content, one or more upload fields where the creator can upload the data set or data sets as set out above, one or more link fields in which the creator can enter an internet address, in particular URL-address providing a link to an external database comprising one or more data sets. This visualized storyboard preferably leads the creator visually, preferably step by step through the creation process of selecting one or more find data information sets and one or more augmented reality show data sets, preferably one or more additional data sets. In other words, the visualized story board enables creators without programming experience/skills to create an internet-based augmented reality content in accordance with the present invention.

The inventive data communication system preferably also allows the creator to manage the self-created augmented reality contents, as the find information data set(s) and augmented reality show data set(s) as well as potential additional data set(s) are stored on or are accessible through the internet-based data processing device, such as an internet-based network, e.g., a cloud network. In case the creator logs into a creator account the inventive data communication system may be configured that the uploaded or accessible data sets may be privately—i.e. third party data communication devices without login data are excluded—sorted and/or searched, one or more data sets may be reused or cross-used for other augmented reality contents. This content management system eliminates the necessity of uploading again the same data set(s) already used for other augmented reality contents.

In addition, the content creating unit may comprise one or more publicly accessible data sets stored in a public library of the content creating unit, in particular find information data sets, augmented reality show data sets, and additional data sets as set out above, e.g. commands for “go to previous step”, “go to next step”, “save”). These publicly available data sets may be searchable and/or sortable.

The features of the inventive embodiments as set out above may be combined in any (sub-)combination and may also include separate features or feature (sub-)combinations of the following detailed description, the dependent claims and/or drawing, as long as the resulting feature combination is reasonable for a person skilled in the art.

The present invention is in the following furthermore described with respect to the accompanying drawing, whereby the invention is not limited to the content of the drawings. The features disclosed in the following may be combined separately or in any combination with the features of the present invention as set out above, as long as the resulting feature combination is reasonable for a person skilled in the art.

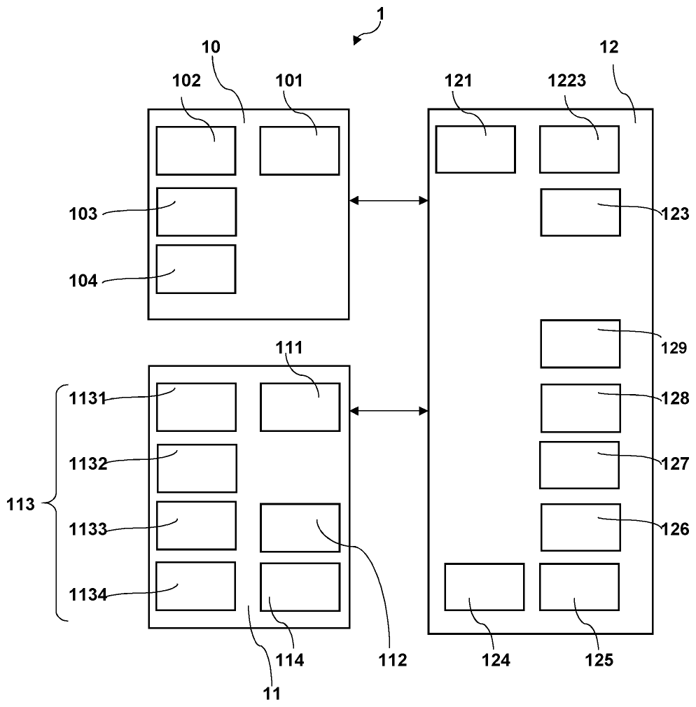

FIG. 1 shows a schematic overview of the inventive data communication system 1 for creating and/or experiencing an internet-based augmented reality content of the first embodiment of the present invention. Accordingly, the data communication system 1 for creating and/or experiencing the content comprises a creator data communication device 10 to be used by a creator, a user data communication device 11 to be used by a user and an internet-based data processing device 12, wherein
a) the creator data communication device 10 comprises an internet access unit 101 with an application programming interface (API) for the internet-based data processing device 12, a display unit 102 for displaying information, a processing unit 103 comprising one or more processors, and an input unit 104 for inputting a data set A for creating the internet-based augmented reality content, wherein the data set A comprises optionally a creator find data set A1 and comprises an augmented reality show data set A2, wherein the creator data communication device 10—which when executed by at least one processor—is configured to send or to provide access to the data set A to the internet-based data processing device 12,
b) the user data communication device 11 comprises an internet access unit 111 with an application programming interface (API) for the internet-based data processing device 12, a display unit 112 for displaying information, one or more sensor units 113, and a processing unit 114 comprising one or more processors, wherein the user data communication device 11—which when executed by at least one processor—is configured to send or provide access to a sensor data set B obtained from the one or more sensor units 113 to the internet-based data processing device 12 and to retrieve the augmented reality show data set A2 from the internet-based data processing device 12 for experiencing the internet-based augmented reality content on the user data communication device 11, and
c) the internet-based data processing device 12 comprises a content creating unit 121, a logic unit 122 and a processing unit 123 comprising one or more processors, wherein the internet-based data processing device 12—which when executed by at least one processor—is configured to store the data set A and create the internet-based augmented reality content in the content creating unit 121, wherein content creating unit 121 is configured to assign an internet address, preferably a URL address, to the internet-based augmented reality content and to send or to provide access to the assigned internet address to the creator data communication device 10 and/or to make publicly available the assigned internet address, and the internet-based data processing device 12 is further configured to compare the sensor data set B received or accessed from the user data communication device 11 with the creator find data set A1 for a predetermined degree of conformity and to send or to provide access to the augmented reality show data set A2 to the user data communication device 11 in case the sensor data set B and the creator find data set A1 match.

The communication between the creator data communication device and the internet-based data processing device 12 and/or the user data communication device 11 and the internet-based data processing device 12 can be established directly or via an intersystem, for example a second or further data processing unit (such as in a cloud server network).

According to a cumulative or alternative further aspect of the present invention, the creator data communication device 10 is present in the form of one, two, three or more separate devices 10. Two or more separate devices 10 may be used by one creator or by two or more separate creators. The two or more devices can be in communication with the internet-based data processing unit 12 at the same time or subsequently. In case two or more separate creators use respective two or more separate creator data communication devices 10, then separate internet-based augmented reality contents are generally created by the two or more separate creators. The one or more creator data communication devices 10 are independently from each other selected from the group consisting of a desktop computer, a laptop computer, a mobile smart device, in particular a smart phone, a smart tablet and a smart wearable, such as smart watch, smart glasses and smart gloves.

According to the present invention the creator data communication device 10 comprises an internet access unit 101 with an application programming interface (API) for the internet-based data processing device 12. In other words, the creator data communication device 10 can access via, e.g. a suitable browser system, the internet-based data processing device 12, which provides the inventive platform for creating and/or experiencing the internet-based augmented reality content.

According to the present invention, the creator data communication device 10 further comprises a display unit 102 for displaying information. Suitable displays 102 may be selected from the group consisting of optical projection systems, monitors, handheld devices, a display system worn on the human body, e.g., eyeglasses, e.g., an eye tap (Generation-2 Glass) and a laser eye tap (Generation-4 Glass), a head-mounted display (HMD), which is a display device worn on the forehead, such as a harness or helmet, bionic contact lenses, or a virtual retina display. Alternatively, the display unit 102 may not make use of special displays such as monitors or head-mounted displays or hand-held devices, but uses digital projectors to display graphical information onto physical objects (so called spatial augmented reality, SAR). The display is in particular beneficial in case the creation steps for creating the augmented reality content is visualized for the creator in form of decision steps, e.g., first step select find information data set and second step selecting augmented reality show data set. When selecting the first and second steps the creator may be enabled, e.g. by a suitable inputting unit 104, to upload or provide access to the respective data sets.

In particular when performing the first step, the creator may be enabled by use of suitable input unit 104 as set out below to select no information or upload or provide access to an optical information data set, preferably an alphanumeric information, a code information, such as a bar code or a Quick Read (QR) code, an image, preferably an image view of a portion of reality and an image of a face, an audio information, a geolocation information and/or a haptic information. Preferably, the creator selects one or more find information data sets from no information, optical information, such as an image (e.g. as data file extension jpg, png, jpeg) or a code, e.g. bar code or QR code, or a geolocation information. Alternatively, the creator may select that the content creating unit 121 converts an input information by the creator into a code, in particular a bar code or a QR code. Access may be provided by an internet accessible link to a library database, such as e.g. flickr® for images, YouTube® for videos and music and SoundCloud® for audio information. Alternatively, the creator may use a find information data set library of the or accessible by the content creating unit 121.

In particular when selecting the second step, the creator may be enabled by use of a suitable input unit 104 to upload or provide access to an optical information data set, preferably an image, a video, a three dimensional (3D) image, text information, html5 information, e.g. in form of a web page, a game, and a survey, and a two or a three dimensional (3D) animation, an audio information, and/or a haptic information. As an example, the creator may be enabled to upload or provide access to an optical information, preferably selected from an image (e.g. as data file extensions jpg, png, jpeg), a 360° image (e.g. as data file extensions jpg, png, jpeg), a video (e.g. as data file extensions mp4, mov, mkv), a 360° video (e.g. as data file extensions mp4, mov, mkv), a three dimensional (3D) image (e.g. as data file extensions gif, Jason, obj, fbx), text information, html5 information, e.g. in form of a web page, a game, and a survey, and a two or a three dimensional (3D) animation (e.g. as data file extensions gif, Jason, obj, fbx), an audio information (mp3). Access may be provided by an internet accessible link to a library database, such as e.g. flickr® for images, YouTube® for videos and music, and SoundCloud® for audio information. Alternatively, the creator may use a find information data set library of the or accessible by the content creating unit 121.

According to the present invention the creator data communication device 10 comprises a processing unit 103 comprising one or more processors. The one or more processors enable the execution of the working steps of the creator data communication device 10. It is obvious that the creator data communication device 10 has access to energy or suitable means so that processing steps can be conducted.

According to the present invention the creator data communication device 10 comprises an input unit 104 for inputting a data set A for creating the internet-based augmented reality content. The input unit 104 generally allows inputting the data set A by any suitable means. According to a cumulative or alternative further aspect of the present invention, the input unit 104 is configured to input the data set A by means of typing, by means of uploading data sets, by means of voice recognition and/or by means of gesture recognition. Uploading data set A, in particular the creator find data set A1 by means of typing, by means or voice recognition or by means of gesture recognition is in particular useful in case a deep learning unit 126 is comprised in the internet-based data processing unit 12.

The data set A comprises optionally a creator find data set A1 and comprises an augmented reality show data set A2. According to a cumulative or alternative further aspect of the present invention, the data set A may further comprise additional data sets for creating the internet-based augmented reality content, such as information on further steps of the internet-based augmented reality content (“go to next step”, “go to previous step”, “save”) or provides interaction means with the user, the so called “call to action” links/hyperlinks.

According to a cumulative or alternative further aspect of the present invention, the creator find data set A1 may be selected from the group consisting of an optical information, preferably an alphanumeric information, a code information, such as a bar code or a Quick Read (QR) code, an image view of a portion of reality and an image of a face, an audio information, a geolocation information and a haptic information. Thus, creator find data set A1 may refer to optical information, audio information, geolocation information and/or haptic information, which the user data communication device 11 needs to identify with the one or more sensors 113. The creator may be enabled to upload or provide access to one or more creator find data sets A1 to the content creating unit 121. Access may be provided by an internet accessible link to a library database, such as e.g. flickr® for images, YouTube® for videos and music, and SoundCloud® for audio information. Alternatively, the creator may use a find information data set from a publicly available library of creator find data sets stored on the or accessible by the content creating unit 121.

According to an example of the present invention the creator find data set A1 may comprise an image of a person or an object or a code, such as a bar code or quick response (QR) code and/or a geolocation position information. In this case the user data communication device 11 needs to identify the respective image of a person or an object or a code, such as a bar code or quick response (QR) code and/or a geolocation position information with suitable one or more sensor units 113 and sends or provides access to an obtained sensor data set B to the internet-based data processing device 12. The logic unit 122 of the internet-based data processing device 12 compares the creator find data set A1 with the sensor data set B. Suitable comparison techniques are available in the prior art. Generally, the data sets are comparable forms with suitable predetermined degrees of conformity, i.e. matching requirements, such as, e.g., minimum feature identity for optical information, such as images and optical codes, or audio information, or a predetermined or adjustable default range for geolocation information. The logic unit is thus configured, i.e. preprogrammed, to compare the creator find data set A1 and the sensor data set B for suitable matching requirements. According to a preferred embodiment, the logic unit may be configured to adjust the predetermined degree of conformity, such as default range for geolocation information, by the creator.

According to a cumulative or alternative further aspect of the present invention, the augmented reality show data set A2 may be selected from the group consisting of an optical information, preferably an image, a video, a three dimensional (3D) image, text information, html5 information, e.g. in form of a web page, a digital game, and a digital survey, and a two or a three dimensional (3D) animation, an audio information and/or a haptic information. The augmented reality show data set A2 may be stored on the creator data communication device 10 or alternatively the creator data communication device 10 has access to the augmented reality show data set A2 via the internet access unit 101. The creator may be enabled to upload or provide access to one or more augmented reality show data sets A2 to the content creating unit 121. Access may be provided by an internet accessible link to a library database, such as e.g. flickr® for images, YouTube® for videos and music, and SoundCloud® for audio information. Alternatively, the creator may use a find information data set of a publicly available library stored on the or accessible by the content creating unit 121.

According to a cumulative or alternative further aspect of the present invention, the user data communication device 11 is present in the form of one, two, three or more separate devices 11. In general, each user data communication device 11 reflects a separate user. The two or more user data communication devices 11 can be in communication with the internet-based data processing unit 12 at the same time or subsequently. The one or more user data communication devices 11 may independently from each other be selected from the group consisting of a laptop computer, a mobile smart device, in particular a smart phone, a smart tablet and a smart wearable, such as a smart watch, smart glasses and smart gloves.

According to the present invention, the user data communication device 11 comprises an internet access unit 111 with an application programming interface (API) for the internet-based data processing device 12. In other words, the user data communication device 11 can access via, e.g. a suitable browser system, the internet-based data processing device 12, which provides the inventive platform for creating and/or experiencing the internet-based augmented reality content.

According to the present invention the user data communication device 11 further comprises a display unit 112 for displaying information. Suitable displays 112 may be selected from the group consisting of optical projection systems, monitors, handheld devices, a display system worn on the human body, e.g., eyeglasses, e.g., an eye tap (Generation-2 Glass) and a laser eye tap (Generation-4 Glass), a head-mounted display (HMD), which is a display device worn on the forehead, such as a harness or helmet, bionic contact lenses, or a virtual retina display. Alternatively, the display unit 112 may not make use of special displays such as monitors or head-mounted displays or hand-held devices, but uses digital projectors to display graphical information onto physical objects (so called spatial augmented reality, SAR).

According to the present invention the user data communication device 11 further comprises one or more sensor units 113. According to a cumulative or alternative further aspect of the present invention, the one or more sensor units 113 are selected from the group consisting of an optical sensor unit 1131, preferably a camera unit, an audio sensor unit 1132, preferably a microphone, a geolocation sensor unit 1133, preferably a GPS unit, and a haptic sensor unit 1134. In other words, the user data communication device 11 is configured to sensor and record with the one or more sensor units 113 a sensor data set B at the same time or subsequently. The sensor data set B may comprise optical, audio, geolocation and/or haptic information. As an example, an image may be taken with a camera as optical sensor unit 1131, alternatively, the geological position may be taken with a GPS unit as geolocation sensor unit 1133.

The one or more sensor units 113—being the same or different sensor unit(s) 113 for sensoring and recording the sensor data B—are also configured to sense and log a reality data set C. The reality data set C is used in combination with the augmented reality show data A2 to alter the reality and experience the augmented reality content. According to a cumulative or alternative further aspect of the present invention, the reality data set C can be the same as the sensor data set B, e.g., the sensor data set B is a visual image of part of reality, such as a face or an object, or an image sequence and the reality data set C is the same visual image or image sequence of part of reality. Alternatively, the reality data set C may be different to the sensor data set B, e.g., the sensor data set B is a visual code information, such as a bar code or a QR code, a recognized gesture information, a geolocation position, an audio information and/or a haptic information, and the reality data set C is a visual image of part of reality other than the visual code information, such as a face or an object, or an image sequence. Alternatively or in addition, the reality data set C may comprise audio information and/or haptic information sensed and logged by the sensor units 113.

According to the present invention the user data communication device 11 comprises a processing unit 114 comprising one or more processors. The one or more processors enable the execution of the working steps of the user data communication device 11. It is obvious that the user data communication device 11 has access to energy or suitable means in order to execute processing steps.

According to the present invention the user data communication device 11 is configured to send or to provide access to the sensor data set B and optionally the reality data set C obtained from the one or more sensor units 113 to the internet-based data processing device 12. According to the present invention the user data communication device 11 is configured to retrieve the augmented reality show data set A2 from the internet-based data processing device 12 so that the internet-based augmented reality content can be experienced by a user using the user data communication device 11 by combining the reality sensor data set C with the augmented reality show data set A2. Alternatively, the combination of the reality data set C and the augmented reality data set A2 is executed on the internet-based data processing device 12 and the combination thereof is sent (pushed) from the internet-based data processing device 12 to the user data communication device 11 for experiencing the augmented reality content on the user data communication device 11. As an aspect of the present invention, the user may experience, in particular view, the internet-based augmented reality content with the user data communication device 11 by conducting one or more steps and optionally activating one or more links or hyperlinks or other means for further actions (so called “call to action”). The user also may refer other potential users to experience, in particular view, the internet-based augmented reality content. In case the user may experience the internet-based augmented reality content by conducting one or more steps, the internet-based augmented reality content comprises generally more than one find information data set, which comprises either no information and one or more creator find data sets A1 or which comprises one or more creator find data sets A1, corresponding to respective augmented reality show data sets A2 and optionally one or more additional data sets. Such a combination of augmented reality step in an augmented reality content is in particular suitable for combining a plurality augmented reality experiences in a gaming or experiential experiences or educational experiences or in retail such as shopping malls, in exhibitions, such as art exhibitions etc.

According to the present invention, the internet-based data processing device 12 comprises a content creating unit 121. The content creating unit 121 comprises suitable operators for creating the internet-based augmented reality content. In particular the content creating unit 121 uses creator find data A1 and augmented reality show data A2 for creating the internet-based augmented reality content. Alternatively, no information is used instead of creator find data A1, which allows that the augmented reality show data A2 is sent to the user communication device without any trigger after the user data communication device 11 accesses the assigned internet address.

According to the present invention, the internet-based data processing device 12 further comprises a logic unit 122. The logic unit 122 in particular is configured to compare the sensor data B with the creator find data A1 for a predetermined degree of conformity. The logic unit 122 is configured with respective operators to identify whether the sensor data set B and creator find data A1 match or not. The term “match” means that the sensor data set B and creator find data A1 have a predetermined degree of conformity. In other words, the logic unit 122 identifies whether the visual information, audio information, geolocation information and/or haptic information of the sensor data set B shows the predetermined conformity (match) with the respective information of the creator find data set A1. As an example, the logic unit 122 identifies whether the image, such as a face or code, in particular bar code or QR code, and/or sound information and/or geolocation information sent as sensor data set B has the predetermined degree of conformity with the creator find data set A1. In case the sensor data set B and the creator find data set A1 match, i.e. have the predefined degree of conformity, the logic unit 122 sends or provides access to the augmented reality show data set A2 to the user data communication device 11 for combination with the reality data set C and experiencing the internet-based augmented reality content. In case the sensor data set C has been sent from the user data communication device 11 to the internet-based data processing device 12, the logic unit may also combine the reality data set C with the augmented reality show data set A2 and send or provide access to the combination thereof to the user data communication device 11 in case the sensor data set B and the creator find data set A1 match.

According to the present invention internet-based data processing device 12 further comprises a processing unit 123 comprising one or more processors. The one or more processors enable the execution of the working steps of the internet-based data processing device 12. It is obvious that the internet-based data processing device 12 has access to energy or a suitable means so that the processing steps can be executed.

According to the present invention, the internet-based data processing device 12 is configured to store the data set A and optionally the sensor data set B and/or the reality data set C in a suitable memory means. Thus, inventive data communication system (platform) allows to manage the content of the augmented reality contents in particular by the creator. In particular the creator may reuse or cross-use certain creator find data sets A1 or augmented reality show data sets A2 in other augmented reality contents (campaigns).

According to an aspect of the present invention, the internet-based data processing device 12 comprises an internet-based server network, preferably a cloud server network.

According to a cumulative or alternative further aspect of the present invention, the content creating unit 121—which when executed by at least one processor—is further configured to assign an internet address, preferably a URL address, to the internet-based augmented reality content and to send the assigned internet address to the creator data communication device 10 and/or to make publicly available the assigned internet address. The internet address, preferably the URL address simplifies the step of sharing of the internet-based augmented reality content with potential users. It also allows the user to experience the most updated augmented reality content, as the augmented reality content may be edited by the creator online on the internet-based data communication device 12 and as the augmented reality content is assigned to the respective internet-address, the internet-based data communication device 12 will push the latest version of the augmented reality content to the user data communication device 11. The assigned internet address of the augmented reality content is typically a URL link to the inventive internet-based data processing device (e.g., www.augmania.co/ . . . , in particular www.augmania.co/redrose). Alternatively, the creator may select to mask the assigned internet address (e.g., www.augmania.co/ . . . , in particular www.augmania.co/redrose) by providing a so called “white labeled” internet address (e.g. www.redrose.com/AR). In the latter case the white labeled internet address, e.g. URL link is redirected, e.g. by DNS, to the assigned internet address of the augmented reality content (augmented reality campaign).

According to a cumulative or alternative further aspect of the present invention, the internet-based data processing device 12 further comprises
a user tracking unit 124—which when executed by at least one processor—is configured to log the one or more user data communication device 11 details and/or to log statistic information about interaction between the one or more user data communication devices 11 and the internet-based augmented reality content, and
a content analytics unit 125—which when executed by at least one processor—is configured to statistically analyze the logged data from the user tracking unit 124 and to provide the analyzed logged statistics data to the creator data communication device 10.

In particular, the user tracking unit 124 is configured, i.e. preprogrammed, to log information about the one or more user data communication devices 11, to log information about the internet access unit 111 of the user data communication device 11, to log information about the location of the user communication device 11 and/or to log information about the sensor data sets B and/or C. Furthermore, the user tracking unit 124 is configured, i.e. preprogrammed, to log information about the internet-based augmented reality content experience by the one or more user data communication devices 11.

The content analytics unit 125 configured, i.e. preprogrammed, to statistically analyze the logged data from the user tracking unit 124 and to provide the analyzed logged statistics data to the creator data communication device 10. According to an aspect of the present invention, the content analytics unit 125 provides the analyzed logged statistics, in particular in form of i) a total number of user data communication devices 11 accessing the internet-based augmented reality content (total content visitors), ii) a total number of experiences (views) of the internet-based augmented reality content (total content viewers), iii) a total number of unique experiences (views) of the internet-based augmented reality content per user data communication devices 11 (total number of unique views), iv) an average number of unique experiences (views) of the internet-based augmented reality content per user data communication device 11 respectively (average unique views), v) a total number of interactions between the user data communication devices 11 and the augmented reality show data A2 (total content interactions), vi) a number of unique interactions between the user data communication devices 11 and the augmented reality show data A2 (unique interactions), vii) an average number of unique interactions between a user data communication device 11 and the augmented reality show data A2 respectively (average unique interactions), viii) a number of experiences (views) per step of the internet-based augmented reality content (total views per step), ix) a number of unique experiences (views) per step of the internet-based augmented reality content by the data communication devices 11 (unique views per step), x) an average number of unique experiences (views) per step of the internet-based augmented reality content by the data communication devices 11 (average unique views per step), xi) a number of total activations of links, hyperlinks or other means of the internet-based augmented reality content (total call to action clicks), xii) a number of unique activations of links, hyperlinks or other means of the internet-based augmented reality content by the data communication devices 11 (unique call to actions), xiii) an average number of unique activations of links, hyperlinks or other means of the internet-based augmented reality content per data communication devices 11 (average unique call to actions), xiv) an engagement time between the user data communication devices 11 and the internet-based augmented reality content (total engagement time), xv) an average engagement time between the user data communication devices 11 and the internet-based augmented reality content (average engagement time), xvi) an engagement time per step of the internet-based augmented reality content by the user data communication devices 11 (total engagement time per content step), xvii) an average engagement time per step of the internet-based augmented reality content by the user data communication devices 11 (average engagement time per content step) and/or xviii) a number of user data communication devices 11 accessing the internet-based augmented reality content in real time (real time visitors).

The content analytics unit 125 may be configured, i.e. preprogrammed, to sort the statistical information, in particular by different types of user data communication devices 11, by different types of internet access units, such as different browsers; and/or by the newest, by ascending or by descending order of access of the internet-based augmented reality content by the user data communication devices 11. The content analytics unit 125 may furthermore be configured, i.e. preprogrammed, to provide the statistical information in form of an excel work-sheet and/or any other means, such as a pdf-document.

This analytical aspect of the present invention is in particular advantageous, as the analyzed logged data is provided to or can be accessed by the creator data communication device 10. The creator thus can access and use the information about the user experience in order to edit the respective internet-based augmented reality content or to improve future internet-based augmented reality contents. In particular, the creator may use the average engagement time per content step to find out which content step may be improved.

According to a cumulative or alternative further aspect of the present invention, the internet-based data processing device 12 further comprises a deep learning unit 126. The deep learning unit 126 comprises or has access to one or more find data images A11. The find data images A11 are preferably tagged with one or more keywords, e.g. an image of a red rose is tagged with the keywords “flower” and/or “rose” and/or “red” and/or “red rose” or are characterized in another suitable way. In case the one or more find data images A11 are not located on the same hardware as the deep learning unit 126 (as possible in cloud server network), the communication between the different hardware means is enabled by suitable means. The deep learning unit 126 comprises suitable means, in particular logic operators and is configured, i.e. preprogrammed, to match the creator find data set A1 with one or more corresponding find data images A111. In other words, the deep learning unit 126 comprises a logic operator, which compares the creator find data set A1 with the find data images A11. In case the creator find data set A1 shows a predetermined degree of conformity (matches) with one or more of the find data images A11 (corresponding find data image(s) A111), then the deep learning unit 126 assigns the one or more corresponding find data images A111 to the creator find data set A1*. In a further step, the logic unit 122 compares the corresponding find data images A111 or the assigned creator find data set A* with the sensor data set B for identifying a predetermined degree of conformity (match). In case the sensor data set B matches with one or more of the corresponding find data images A111, the logic unit 122 sends or provides access to the augmented reality show data set A2 to the user data communication device 11 for experiencing the internet-based augmented reality content. The inventive data communication system 1 comprising the deep learning unit 126 is in particular advantageous, as it may simplify inputting the creator find data set A1 for the creator, in particular in case a general item of reality, e.g., any “red rose”, any “chair” etc. shall function as creator find data in order to trigger sending or providing access to the augmented reality show data A2 for experiencing the internet-based augmented reality content to the user data communication device 11. Furthermore, this deep learning unit 126 may be advantageous in case the creator find data set A1 may be inputted by a creator in form of a general description, such as a verbal or written description of an item, e.g. “red rose”, “chair”, using typing inputting means or voice recognition inputting means.

According to a cumulative or alternative further aspect of the present invention, the internet-based data processing device 12 further comprises an artificial intelligence unit 127 to assist the process of creating the internet-based augmented reality content and/or to assist the process of experiencing the internet-based augmented reality content. The artificial intelligence unit 127 generally comprises one or more suitable logic operators and in particular comprises suitable keywords for creating the internet-based augmented reality content by the creator and/or executing the internet-based augmented reality content by the user. The keywords are assigned with predetermined suitable answers. According to an example of the present invention the artificial intelligence unit 127 is represented by a robotic chat box which provides answers to questions submitted by the creator or the user. In case the artificial intelligence unit 127, in particular the robotic chat box identifies one or more keywords in a question submitted by the creator or the user with a suitable inputting means, the artificial intelligence unit 127, in particular robotic chat box provides one or more predetermined suitable answers. The inventive data communication system 1 comprising the artificial intelligence unit 127 is in particular advantageous, as it may reduce time for creating and/or executing the internet-based augmented reality content. Such an internet-based artificial intelligence unit 127 support is further advantageous, as it contains the latest updates of the keywords and assigned questions. Furthermore, the internet-based artificial intelligence unit 127 reduces support costs as the number human support staff can be reduced.

According to a cumulative or alternative further aspect of the present invention, the internet-based data processing device 12 further comprises an augmented reality interaction unit 128. The augmented reality interaction unit 128 generally comprises suitable means, in particular logic operator(s) and is configured, i.e. preprogrammed, to provide interactions between the user data communication device 11 and the augmented reality show data A2. In other words, the augmented reality interaction unit 128 enables interactions between the user data communication device 11 and the augmented reality show data A2 in such a way, that a predetermined, i.e. preprogrammed, action executed on the user data communication device 11 triggers a predetermined action of the augmented reality show data A2. As an example, in case the user data communication device is turned (moved) in accordance with a predetermined action, a sensor unit 113, such as acceleration sensor, sends or providing access to this predetermined action information to the augmented reality interaction unit 128 and activates the action of the augmented reality show data, such as shooting a “ball” as the augmented reality show data into a predetermined direction. The inventive data communication system 1 comprising the augmented reality interaction unit 128 is in particular advantageous, as it allows individual experiences of the internet-based augmented reality content by individual users. In case the inventive data communication system 1 comprises the augmented reality interaction unit 128, then the user tracking unit 124 is in particular configured, i.e. preprogrammed, to log the interaction actions executed by the user data communication device 11 and to provide this information to the creator data communication device 10.

According to a cumulative or alternative further aspect of the present invention, the internet-based data processing device 12 further comprises a previewing unit 129—which when executed by at least one processor—is configured, i.e. preprogrammed, to provide a previewing simulation of the internet-based augmented reality content to the creator data communication device 10. In other words, the previewing unit 129 is configured, i.e. preprogrammed, to simulate the internet-based augmented reality content in action prior to publishing the content. According to a preferred aspect, the previewing unit 129 comprises one or more simulation sensor data sets B* and one or more simulation reality data sets C*, wherein the one or more simulation sensor data sets B* and simulation reality data sets C* are tagged with one or more find data set A1 categories. For example, the one or more simulation sensor data sets B* and simulation reality data sets C* may be tagged with categories such as a “geographic location” and provide an image or an image sequence (video) of a geographic location, in particular a corresponding geographic location of the find data set A1. Alternatively or cumulatively, the one or more simulation sensor data sets B* and simulation reality data sets C* may be tagged with “face detection” and provide an image or an image sequence (video) including a face. Further alternatively or cumulatively, the one or more simulation sensor data sets B* and simulation reality data sets C* may be tagged with “image of objects” and may provide an image or an image sequence of objects, wherein preferably the specific objects are additionally tagged, such as “rose”, “chair” etc. Alternatively or cumulatively, the one or more simulation sensor data sets B* and simulation reality data sets C* may be tagged with “audio information” and/or “haptic information” and may provide respective audio and/or haptic information. The previewing unit 129 is further configured, i.e. preprogrammed, to simulate the internet-based augmented reality content in action in form of an image sequence, preferably video with or without audio information, using the tagged simulation sensor data sets B* and C*, which have a predetermined degree of conformity with the find data set A1. As an example, the find data set A1 refers to a geographic location, the previewing unit 129 will select a simulation sensor data set B* and a simulation reality data set C* tagged with “geographic location”, preferably corresponding to the selected geographic location of find data set A1. Alternatively or cumulatively, in case the find data set A1 relates to the provision of a face recognition means, a simulation sensor data set B* and a simulation reality data set C* will be selected which are (additionally) tagged with “face detection”. Alternatively or cumulatively, in case the find data set A1 relates to an image of an object, in particular a specified object, a simulation sensor data set B* and a simulation reality data set C* will be selected which are (additionally) tagged with “image of object”, preferably an image or image sequence of the corresponding specified object. Alternatively or cumulatively, in case the find data set A1 relates to provide an audio or haptic information, then a simulation sensor data set B* and a simulation reality data set C* will be selected which will (additionally) tagged with “audio information” and/or “haptic information”.

The expression “cumulative or alternative further aspect of the present invention” is defined in accordance with the present invention in that the first to fourth embodiments of the present invention comprise the respective aspect and examples thereof in accumulation with the essential aspects and none (“alternative”) or one, two, three, four, five or more, in particular all further aspects (“cumulative”) of the present invention.

All aspects as well as combination of aspects of the first embodiment of the present invention also apply to the further embodiments of the present invention.

According to the second embodiment of the present invention a method for creating an internet-based augmented reality content using the inventive data communication system 1 of the first embodiment is provided, characterized in that the inventive method comprises or consists of the following steps:
a) Providing an internet-based data processing device 12 comprising a content creating unit 121, a logic unit 122 and a processing unit 123 comprising one or more processors,
b) Providing a creator data communication device 10 comprising an internet access unit 101 with an application programming interface (API) for the internet-based data processing device 12, a display unit 102 for displaying information, a processing unit 103 comprising one or more processors, and an input unit 104 for inputting a data set A for creating the internet-based augmented reality content, wherein the data set A optionally comprises a creator find data set A1 and comprises an augmented reality show data set A2, and accessing the internet-based data processing device 12,
c) Sending or providing access to the data set A optionally comprising the creator find data set A1 and comprising the augmented reality show data set A2 from the creator data communication device 10 to the internet-based data processing device 12,
d) Creating the internet-based augmented reality content with the content creating unit 121, and
e) Assigning an internet address, preferably a URL address to the internet-based augmented reality content by the internet-based data communication device 12 and sending or providing access to the assigned internet address of the internet-based augmented reality content to the creator data communication device 10 or making publicly available the assigned internet address of the internet-based augmented reality content.

All aspects as well as combination of aspects of the inventive data communication system 1 of the first embodiment of the present invention also apply to the inventive method of the second embodiment of the present invention.

According to an example of the inventive method, step d) at least comprises the steps of adding a creator find data set A1 and adding the augmented reality show data set A2. The creator find data set A1 is sent to the internet-based data processing device 12 and may be selected from the group of an image, in particular a code such as a bar code or a QR code, and/or an image of a face, a geolocation data set, an audio data set and/or a haptic data set. The augmented reality show data set A2 is sent to the internet-based data processing device 12 and may be selected from an image or image sequence, in particular a three dimensional image or a three dimensional animation, an audio data set, a geolocation data set and/or a haptic data set.

According to a cumulative or alternative further aspect of the inventive method, the internet-based data processing device 12 further comprises a deep learning unit 126 comprising or having access to find data images A11, wherein in step d) the internet-based augmented reality content is created with the content creating unit 121 and the deep learning unit 126, wherein the creator find data set A1 is compared with the one or more find data images A11 and in case one or more corresponding find data images A111 match with the creator find data set A1 at least part, preferably all corresponding find data images A111 are assigned to the creator find data set A1*. The deep learning unit 126 is described in more detail with the first embodiment of the present invention hereinbefore.

The find data images A11 are preferably tagged with one or more keywords, e.g. an image of a red rose is tagged with the keywords “flower” and/or “rose” and/or “red” and/or “red rose” or are characterized in another suitable way. In case the one or more find data images A11 are not located on the same hardware as the deep learning unit 126 (as possible in cloud server network), the communication between the different hardware means is enabled by suitable means. The deep learning unit 126 comprises suitable means, in particular logic operators and is configured, i.e. preprogrammed, to match the creator find data set A1 with one or more corresponding find data images A111. In other words, the deep learning unit 126 comprises a logic operator, which compares the creator find data set A1 with the one or more find data images A11. In case the creator find data set A1 shows a predetermined degree of conformity (matches) with one or more of the find data images A11 (corresponding find data image(s) A111), then the deep learning unit 126 assigns the one or more corresponding find data images A111 to the creator find data set A1*. The corresponding find data images A111 or the assigned creator find data set A* is then used in the inventive method for experiencing the internet-based augmented reality content.

The use of the deep learning unit 126 in the inventive method for creating the internet-based augmented reality content is in particular advantageous, as it may simplify inputting the creator find data set A1 for the creator, in particular in case a general item of reality, e.g., any “red rose”, any “chair” etc. shall function as creator find data in order to trigger sending or providing access to the augmented reality show data A2 for experiencing the internet-based augmented reality content to the user data communication device 11. Furthermore, this deep learning unit 126 may be advantageous in case the creator find data set A1 may be inputted by a creator in form of a general description, such as a verbal or written description of an item, e.g. “red rose”, “chair”, using typing inputting means or voice recognition inputting means.

According to a cumulative or alternative further aspect of the inventive method, the internet-based data processing device 12 further comprises an artificial intelligence unit 127, wherein in step d) the creating of the internet-based augmented reality content is assisted by the artificial intelligence unit 127. The artificial intelligence unit 127 is described in more detail with the first embodiment of the present invention hereinbefore.

The artificial intelligence unit 127 generally comprises one or more suitable logic operators and in particular comprises suitable keywords for creating the internet-based augmented reality content by the creator and/or executing the internet-based augmented reality content by the user. The keywords are assigned with predetermined, i.e. preprogrammed, suitable answers. According to an example of the present invention the artificial intelligence unit 127 is represented by a robotic chat box which provides answers to questions submitted by the creator or the user. In case the artificial intelligence unit 127, in particular the robotic chat box identifies one or more keywords in a question submitted by the creator, the artificial intelligence unit 127, in particular robotic chat box provides one or more predetermined suitable answers. The use of the artificial intelligence unit 127 in the inventive method of creating an internet-based augmented reality content is in particular advantageous, as it may reduce time for creating the internet-based augmented reality content. Such an internet-based artificial intelligence unit 127 support is further advantageous, as it contains the latest updates of the keywords and assigned questions. Furthermore, the internet-based artificial intelligence unit 127 reduces support costs as the number human support staff can be reduced.

According to a cumulative or alternative further aspect of the inventive method, the internet-based data processing device 12 further comprises a previewing unit 129, wherein in step d) a previewing simulation of the internet-based augmented reality content is provided to or can be accessed by the creator data communication device 10. In other words, the previewing unit 129 is configured, i.e. preprogrammed, to simulate the internet-based augmented reality content in action prior to publishing the content. According to a preferred aspect, the previewing unit 129 comprises one or more simulation sensor data sets B and one or more simulation sensor data sets C, wherein the one or more simulation sensor data sets B and simulation reality data sets C* are tagged with one or more find data set A1 categories. For example, the one or more simulation sensor data sets B and simulation reality data sets C* may be tagged with categories such as a “geographic location” and provide an image or an image sequence (video) of a geographic location, in particular a corresponding geographic location of the find data set A1. Alternatively or cumulatively, the one or more simulation sensor data sets B and simulation reality data sets C* may be tagged with “face detection” and provide an image or an image sequence (video) including a face. Further alternatively or cumulatively, the one or more simulation sensor data sets B and simulation reality data sets C* may be tagged with “image of objects” and may provide an image or an image sequence of objects, wherein preferably the specific objects are additionally tagged, such as “rose”, “chair” etc. Alternatively or cumulatively, the one or more simulation sensor data sets B and simulation reality data sets C* may be tagged with “audio information” and/or “haptic information” and may provide respective audio and/or haptic information. The previewing unit 129 is further configured, i.e. preprogrammed, to simulate the internet-based augmented reality content in action in form of an image sequence, preferably video with or without audio information, using the tagged simulation sensor data sets B and C, which have a predetermined degree of conformity with the find data set A1. As an example, the find data set A1 refers to a geographic location, the previewing unit 129 will select a simulation sensor data set B* and a simulation reality data set C* tagged with “geographic location”, preferably corresponding to the selected geographic location of find data set A1. Alternatively or cumulatively, in case the find data set A1 relates to the provision of a face recognition means, a simulation sensor data set B* and a simulation reality data set C* will be selected which are (additionally) tagged with “face detection”. Alternatively or cumulatively, in case the find data set A1 relates to an image of an object, in particular a specified object, a simulation sensor data set B* and a simulation reality data set C* will be selected which are (additionally) tagged with “image of object”, preferably an image or image sequence of the corresponding specified object. Alternatively or cumulatively, in case the find data set A1 relates to provide an audio or haptic information, then a simulation sensor data set B* and a simulation reality data set C* will be selected which will (additionally) tagged with “audio information” and/or “haptic information”.

According to the third embodiment of the present invention, a method for experiencing an internet-based augmented reality content using the inventive data communication system 1 is provided, characterized in that the method comprises or consists of the following steps:
a) Providing an internet-based data processing device 12 comprising a content creating unit 121 and a stored internet-based augmented reality content comprising a data set A with optionally a creator find data set A1 and with an augmented reality show data set A2, a logic unit 122 and a processing unit 123 comprising one or more processors,
b) Assigning an internet address, preferably a URL address, to the stored internet-based augmented reality content of step a),
c) Providing a user data communication device 11 comprising an internet access unit 111 with an application programming interface (API) for the internet-based data processing device 12, a display unit 112 for displaying information, one or more sensor units 113, and a processing unit 114 comprising one or more processors, and accessing the internet-based data processing device 12 by use of the assigned internet address of step b),
d) Optionally recording a sensor data set B with the one or more sensor units 113 and sending or providing access to the sensor data set B to the internet-based data processing device 12,
e) Optionally comparing the sensor data set B with the creator find data set A1 for a predetermined degree of conformity by use of the logic unit 122 and sending or providing access to the augmented reality show data set A2 from the internet-based data processing device 12 to the user data communication device 11 in case the sensor data set B and the creator find data set A1 match or sending or providing access to the augmented reality show data set A2 from the internet-based data processing device 12 to the user data communication device 11 after accessing the internet-based data processing device 12 by the user data communication device 11, and
f) Experiencing the internet-based augmented reality content on the user data communication device 11 by adding the augmented reality show data set A2 to a reality data set C recorded by one or more of the sensor units 113 and displaying the combination thereof.

All aspects as well as combination of aspects of the inventive data communication system 1 of the first embodiment of the present invention also apply to the inventive method of the third embodiment of the present invention.

According to a cumulative or alternative further aspect of the inventive method, the internet-based data processing device 12 further comprises a user tracking unit 124 and a content analytics unit 125, wherein the method comprises or consists of the following steps:
g) Tracking the user data communication device 11 with the user tracking unit 124 of the internet-based data processing device 12 thereby logging one or more user data communication device 11 details and/or logging statistic information about interaction between the one or more user data communication devices 11 and the internet-based augmented reality content,
h) Providing a creator data communication device 10 comprising an internet access unit 101 with an application programming interface (API) for the internet-based data processing device 12, a display unit 102 for displaying information, a processing unit 103 comprising one or more processors, and an input unit 104 for inputting a data set A for creating the internet-based augmented reality content and accessing the internet-based data processing device 12, and
i) Statistically analyzing the logged data from the user tracking unit 124 with the content analytics unit 125, and sending or providing access to the analyzed logged statistics data to the creator data communication device 10.

The user tracking unit 124 and a content analytics unit 125 are described in more detail with the first embodiment of the present invention hereinbefore.

In particular, the user tracking unit 124 is configured, i.e. preprogrammed, to log information about the one or more user data communication devices 11, to log information about the internet access unit 111 of the user data communication device 11, to log information about the location of the user communication device 11 and/or to log information about the sensor data sets B and/or C. Furthermore, the user tracking unit 124 is configured, i.e. preprogrammed, to log information about the internet-based augmented reality content experience by the one or more user data communication devices 11.

The content analytics unit 125 configured, i.e. preprogrammed, to statistically analyze the logged data from the user tracking unit 124 and to provide the analyzed logged statistics data to the creator data communication device 10. According to an aspect of the present invention, the content analytics unit 125 provides the analyzed logged statistics, in particular in form of i) a total number of user data communication devices 11 accessing the internet-based augmented reality content (total content visitors), ii) a total number of experiences (views) of the internet-based augmented reality content (total content viewers), iii) a total number of unique experiences (views) of the internet-based augmented reality content per user data communication devices 11 (total number of unique views), iv) an average number of unique experiences (views) of the internet-based augmented reality content per user data communication device 11 respectively (average unique views), v) a total number of interactions between the user data communication devices 11 and the augmented reality show data A2 (total content interactions), vi) a number of unique interactions between the user data communication devices 11 and the augmented reality show data A2 (unique interactions), vii) an average number of unique interactions between a user data communication device 11 and the augmented reality show data A2 respectively (average unique interactions), viii) a number of experiences (views) per step of the internet-based augmented reality content (total views per step), ix) a number of unique experiences (views) per step of the internet-based augmented reality content by the data communication devices 11 (unique views per step), x) an average number of unique experiences (views) per step of the internet-based augmented reality content by the data communication devices 11 (average unique views per step), xi) a number of total activations of links, hyperlinks or other means of the internet-based augmented reality content (total call to action clicks), xii) a number of unique activations of links, hyperlinks or other means of the internet-based augmented reality content by the data communication devices 11 (unique call to actions), xiii) an average number of unique activations of links, hyperlinks or other means of the internet-based augmented reality content per data communication devices 11 (average unique call to actions), xiv) an engagement time between the user data communication devices 11 and the internet-based augmented reality content (total engagement time), xv) an average engagement time between the user data communication devices 11 and the internet-based augmented reality content (average engagement time), xvi) an engagement time per step of the internet-based augmented reality content by the user data communication devices 11 (total engagement time per content step), xvii) an average engagement time per step of the internet-based augmented reality content by the user data communication devices 11 (average engagement time per content step) and/or xviii) a number of user data communication devices 11 accessing the internet-based augmented reality content in real time (real time visitors).

The content analytics unit 125 may be configured, i.e. preprogrammed to sort the statistical information, in particular by different types of user data communication devices 11, by different types of internet access units, such as different browsers; and/or by the newest, by ascending or by descending order of access of the internet-based augmented reality content by the user data communication devices 11. The content analytics unit 125 may furthermore be configured, i.e. preprogrammed to provide the statistical information in form of an excel work-sheet and/or any other means, such as a pdf-document.

This analytical aspect of the present invention is in particular advantageous, as the analyzed logged data is provided to or can be accessed by the creator data communication device 10. The creator thus can access and use the information about the user experience in order to edit the respective internet-based augmented reality content or to improve future internet-based augmented reality contents. In particular, the creator may use the average engagement time per content step to find out which content step may be improved.

According to a cumulative or alternative further aspect of the inventive method, the internet-based data processing device 12 further comprises a deep learning unit 126 comprising one or more find data images A11, wherein in step a) a creator find data set A1* is provided, which comprises the creator find data set A1 and one or more corresponding find data images A111 assigned thereto, wherein the corresponding find data images A111 match with the creator find data set A1, and in step e) the sensor data set B is compared with the one or more corresponding find data images A111 or the creator find data set A1* and the augmented reality show data set A2 is sent from the internet-based data processing device 12 to the user data communication device 11 in case the sensor data set B and the corresponding find data images A111 or the creator find data set A1* match.

The use of the deep learning unit 126 in the inventive method for experiencing the internet-based augmented reality content is in particular advantageous, as—in case a general item shall be identified by the user, such as a “red rose”, a “chair” etc.—it increases the chances of matching the sensor data set B with the creator find data set A1/A1*.

According to a cumulative or alternative further aspect of the inventive method, the internet-based data processing device 12 further comprises an artificial intelligence unit 127, wherein the method for experiencing the internet-based augmented reality content is assisted by the artificial intelligence unit 127.

According to a cumulative or alternative further aspect of the inventive method, the internet-based data processing device 12 further comprises an augmented reality interaction unit 128. The augmented reality interaction unit generally comprises suitable means, in particular logic operator(s) and is configured, i.e. preprogrammed, to provide interactions between the user data communication device 11 and the augmented reality show data A2. In other words, the augmented reality interaction unit 128 enables interactions between the user data communication device 11 and the augmented reality show data A2 in such a way, that a predetermined action executed on the user data communication device 11 triggers a predetermined action of the augmented reality show data A2. As an example, in case the user data communication device is turned (moved) in accordance with a predetermined action, a sensor unit 113, such as acceleration sensor, sends or provides access to this predetermined action information to the augmented reality interaction unit 128 and activates the action of the augmented reality show data, such as shooting a “ball” (the augmented reality show data A2) into a predetermined direction. The use of the augmented reality interaction unit 128 is in particular advantageous, as it allows individual experiences of the internet-based augmented reality content by individual users. In case the inventive data communication system 1 comprises the augmented reality interaction unit 128, then the user tracking unit 124 is in particular configured, i.e. preprogrammed, to log the interaction actions executed by the user data communication device 11 and to provide this information to the creator data communication device 10.

According to a cumulative or alternative further aspect of the present invention, the internet-based data processing device 12 further comprises a previewing unit 129—which when executed by at least one processor—is configured, i.e. preprogrammed, to provide a previewing simulation of the internet-based augmented reality content to the creator data communication device 10. In other words, the previewing unit 129 is configured, i.e. preprogrammed, to simulate the internet-based augmented reality content in action prior to publishing the content. According to a preferred aspect, the previewing unit 129 comprises one or more simulation sensor data sets B* and one or more simulation reality data sets C*, wherein the one or more simulation sensor data sets B* and simulation reality data sets C* are tagged with one or more find data set A1 categories. For example, the one or more simulation sensor data sets B* and simulation reality data sets C* may be tagged with categories such as a “geographic location” and provide an image or an image sequence (video) of a geographic location, in particular a corresponding geographic location of the find data set A1. Alternatively or cumulatively, the one or more simulation sensor data sets B* and simulation reality data sets C* may be tagged with “face detection” and provide an image or an image sequence (video) including a face. Further alternatively or cumulatively, the one or more simulation sensor data sets B* and simulation reality data sets C* may be tagged with “image of objects” and may provide an image or an image sequence of objects, wherein preferably the specific objects are additionally tagged, such as “rose”, “chair” etc. Alternatively or cumulatively, the one or more simulation sensor data sets B* and simulation reality data sets C* may be tagged with “audio information” and/or “haptic information” and may provide respective audio and/or haptic information. The previewing unit 129 is further configured, i.e. preprogrammed, to simulate the internet-based augmented reality content in action in form of an image sequence, preferably video with or without audio information, using the tagged simulation sensor data sets B* and C*, which have a predetermined degree of conformity with the find data set A1. As an example, the find data set A1 refers to a geographic location, the previewing unit 129 will select a simulation sensor data set B* and a simulation reality data set C* tagged with “geographic location”, preferably corresponding to the selected geographic location of find data set A1. Alternatively or cumulatively, in case the find data set A1 relates to the provision of a face recognition means, a simulation sensor data set B* and a simulation reality data set C* will be selected which are (additionally) tagged with “face detection”. Alternatively or cumulatively, in case the find data set A1 relates to an image of an object, in particular a specified object, a simulation sensor data set B* and a simulation reality data set C* will be selected which are (additionally) tagged with “image of object”, preferably an image or image sequence of the corresponding specified object. Alternatively or cumulatively, in case the find data set A1 relates to provide an audio or haptic information, then a simulation sensor data set B* and a simulation reality data set C* will be selected which will (additionally) tagged with “audio information” and/or “haptic information”.

The present invention is described herein below in view of an example embodiment, which does not limit the scope of the invention. Features described with respect to the example embodiment may be separately or in any (sub)combination be combined with one or more features of inventive embodiments as described hereinbefore, as long as the final feature combination is reasonable to a person skilled in the art.

### Detailed Description of an Example Embodiment

According to an example embodiment, the inventive data communication system 1 for creating and/or experiencing an internet-based augmented reality content comprises a creator data communication device 10 to be used by a creator, which is selected from the group consisting of a computer, desktop computer, a laptop computer, a mobile smart device, in particular a smart phone, or a smart tablet. In the following the term “computer 10” is used to refer to the creator data communication device 10.

The computer 10 comprises certain operating units, such as an internet access unit 101 with an application programming interface (API) for the internet-based data processing device (12). The internet access unit 101 can be any suitable web browser (in the following “browser”) retrieving, presenting and traversing information resources on the internet (world wide web) based data processing device 12. The information resource is identified by a Uniform Resource Identifier (URI/URL).

Furthermore, the computer 10 comprises a display unit 102 for displaying information. Any suitable display as described hereinbefore can be used, in particular a monitor.

Furthermore, the computer 10 comprises a processing unit 103 comprising one or more processors. The processors are configured to enable carrying out the operating steps.

Furthermore, the computer 10 comprises an input unit 104 for inputting a data set A for creating the content. The data set A may be put in by typing characters, in particular alphanumeric characters, by voice recognition, by uploading or providing an internet link (URI/URL) for data sets on images or image sequences, three dimensional images or image sequences, and/or geolocation information. The data set A comprises a creator find data set A1 and an augmented reality show data set A2. Alternatively, the data set A comprises no information instead of a creator find data set A1 and comprises an augmented reality show data set A2. In the latter case, no trigger is necessary to push the augmented reality content from the computer 10 to the user data communication device 11.

The inventive data communication system 1 further comprises a user data communication device 11 to be used by a user, which is independently from each other selected from the group consisting of a laptop computer, a mobile smart device, in particular a smart phone, a smart tablet and a smart wearable, such as a smart watch, smart glasses and smart gloves. In the present example the user data communication device 11 is a mobile smart device, such as a smart phone or smart tablet. In the following the term “smart device 11” is used to refer to the user data communication device 11.

The smart device 11 comprises certain operating units, such as an internet access unit 111 with an application programming interface (API) for the internet-based data processing device 12. The internet access unit 111 can be any suitable web browser (in the following “browser”) retrieving, presenting and traversing information resources on the internet (world wide web) based data processing device 12.

Furthermore, the smart device 11 comprises a display unit 112 for displaying information. Any suitable display as described hereinbefore can be used, in particular a display device of a smart phone and/or a smart tablet.

Furthermore, the smart device 11 comprises one or more sensor units 113. The one or more sensor units 113 comprise a camera unit, a microphone unit, and a geolocation identifying unit, such as a GPS unit. The one or more sensor units 113 sensor the sensor data set B and the same or different sensor units 113 sensor the sensor data set C.

The inventive data communication system 1 further comprises an internet-based data processing device 12, which represents an internet-based server network. In the present example a cloud server network is used as the internet-based data processing device 12. In one or more operating units are located on different hardware systems of the cloud server network, then it is obvious to the skilled person that in case the operating units need to be accessed the cloud server network provides suitable means for providing the respective access. In the following the term “cloud 12” is used to refer to the internet-based data processing device 12.

The cloud 12 comprises certain operating units, in particular a content creating unit 121, a logic unit 122 and a processing unit 123 comprising one or more processors.

The content creating unit 121 of the cloud 12 comprises means and is configured, i.e. preprogrammed, to create the augmented reality content. Detailed information on how the content creating unit 121 is configured, i.e. preprogrammed to create the augmented reality content is described in the general description hereinbefore, in particular with respect to the first embodiment of the invention. In this respect, the content creating unit 121 is in data communication with the computer 10. Upon a predefined action of the creator, the computer 10 sends or provides access to the data set A to the cloud 12 so that the content creating unit 121 can create the augmented reality content. The data set A comprises at least the creator find data set A1 and the augmented reality show data set A2. The content creating unit 121 comprises suitable means to create the content based on the data set A. The content creating unit 121 may also comprise a storyboard template for creating the content, which is described in more detail in the general description of the invention hereinbefore, in particular with respect to the first embodiment of the invention. The content creating unit provides suitable means in order to execute the content by a potential user. In particular, the content creating unit 121 is configured, i.e. preprogrammed, to assign an internet address, preferably a URL address, to the content and to send or to provide access to the assigned internet address to the creator data communication device (10) and/or to make publicly available the assigned internet address so that a potential user may execute the content.

The logic unit 122 of the cloud 12 comprises means and is configured, i.e. preprogrammed, to compare the sensor data set B with the creator find data set A1.

In case the cloud 12 comprises a user tracking unit 124 and a content analytics unit 125, the logic unit 122 may be further configured, i.e. preprogrammed, to assist the content analytics unit 125 in analyzing the logged data from the user tracking unit 124.

In case the cloud 12 comprises a deep learning unit 126, the logic unit 122 may be further configured, i.e. preprogrammed, to compare the comprised one or more find data images A11 with the creator find data set A1 and in case one or more of the find data images A11 show a predetermined degree of conformity with the creator find data set A1 one or more corresponding find data images A111 are assigned to the creator data set A1*.

In case the cloud 12 comprises an artificial intelligence unit 127, the logic unit 122 may be further configured, i.e. preprogrammed, to assist the artificial intelligence unit 127 in analyzing the keywords provided by the creator and/or user to provide a suitable answer.

In case the cloud 12 comprises an augmented reality interaction unit 128, the logic unit 122 may be further configured, i.e. preprogrammed, to assist the augmented reality interaction unit 128 in providing interactions between the smart device 11 and the augmented reality show data A2.

In case the cloud 12 comprises a previewing unit 129, the logic unit 122 may be further configured, i.e. preprogrammed, to assist previewing unit 129 in providing (access to) a previewing simulation to the creator data communication device.

As an example, the inventive data communication system 1 in particular allows the following operating processes for creating the internet-based augmented reality content:

The creator accesses with the browser of a computer 10 a web page of the cloud 12 providing the inventive platform for creating the content. The information about creating the internet-based augmented reality content is displayed on the respective display/monitor.

The creator may be asked to “sign up” or “sign in” in order to open a web-page to be used by the creator only. Such a “sign up”/“sign in” is advantageous to facilitate that an internet-based augmented reality content is only created, edited, published and deleted by dedicated creators and/or content analytics information is only viewed by the dedicated creators. Furthermore, the “sign up”/“sign in” facilitates the inventive platform provider to set up a payment system for use of the inventive platform.

After accessing the web page of the cloud 12 for providing the inventive platform for creating the content, in particular after “signing up” or “singing in” the creator may view a list of internet-based augmented reality contents already created and/or can access a web page for creating a new internet-based augmented reality content. The web page for creating a new internet-based augmented reality content may comprise a storyboard template for creating the content. The expression “storyboard template” means in connection with the present invention that a preprogrammed storyboard for a content is provided, wherein the creator is only requested to add certain information, in particular the creator find data set A1 and the augmented reality show data set. The internet-based data processing device 12, in particular the cloud 12 may also provide a tutorial unit 1210 (not separately shown in FIG. 1), which assists the creator to learn creating an internet-based augmented reality content. Such a tutorial unit 1210 is preferably operated in combination with the previewing unit 129 in order to increase the ability to improve the user experience of the internet-based augmented reality content.

Based on the template of a content story board, the creator then creates the new content. The creator is requested to add the creator find data set A1. Upon request the creator puts in the creator find data set A1. Alternatively the creator chooses “nothing”/“no information”, which means that no creator find data set A1 is necessary in order to display the augmented reality show data set A2 on the user data communication device 11. As an example for submitting a creator find data set A1, the creator may be requested to add an image. In case the creator find data set is an image, the creator will upload the image to the web page of the cloud 12 for creating the content or will send or provide access to a URL which represents the respective image information. In addition or alternatively, the creator may be requested to add a QR code or a bar code. In case the creator find data set (also) comprises a QR code and/or bar code, the creator will upload the respective codes to the web page of the cloud 12 for creating the content or will send or provide access to a URL which represents the respective code information. Alternatively, the content creating unit 121 is preferably configured, i.e. preprogrammed, to establish respective codes upon an input of the creator. In addition or alternatively, the creator may be requested to activate a face detection unit. In case the creator find data set (also) uses face detection technology, the creator will activate the face detection unit as creator find data A1. In addition or alternatively, the creator may be requested to add geolocation information. In case the creator find data set (also) comprises geolocation information, the creator uploads the respective geolocation information or provides a link to the respective geolocation information or selects the respective geolocation information on a geological map.

In a further step the creator is requested to add augmented reality show data set A2. In case the augmented reality show data set A2 is represented by an image or an image sequence, the creator will upload or provide a link for the respective image including a 360° image (suitable file extensions are jpg, png, jpeg, the inventive content creating unit 121 may be preprogrammed to convert other file extensions into a suitable file extension) or image sequence (video) including a 360° video (suitable file extensions are mp4, mov, mkv, the inventive content creating unit 121 may be preprogrammed to convert other file extensions into a suitable file extension). In addition or alternatively, in case the augmented reality show data set A2 is represented by a three dimensional object or a two or three dimensional animation, the creator will upload or provide a link for the respective three dimensional object or the two or three dimensional animation (suitable file extensions are gif, jason, obj, fbx, the inventive content creating unit 121 may be preprogrammed to convert other file extensions into a suitable file extension). In addition or alternatively, in case the augmented reality show data set A2 is represented by an audio information, the creator uploads or sends or provides access to a link to the respective audio information (suitable file extensions is mp3, the inventive content creating unit 121 may be preprogrammed to convert other file extensions into a suitable file extension). In addition or alternatively, in case the augmented reality show data set A2 is represented by a text information, the content creating unit 121 is preferably configured, i.e. preprogrammed, to provide a text field into which the creator can put in the text information. In addition or alternatively, in case the augmented reality show data set A2 is represented by html5 information, the content creating unit 121 is preferably configured, i.e. preprogrammed, to provide a field for putting in the respective html5 information, e.g. in form of a web page, a game, and a survey.

The creator may provide respective augmented reality show data sets by uploading one or more files or by providing a link to an internet accessible data base, such as flickr® for images, YouTube® for videos or music, SoundCloud® for audio files. Alternatively, the creator may select a respective file of a predefined augmented reality show data set library comprising one or more augmented reality show data sets A2 stored on or accessed by the cloud 12. The creator may in a preferred embodiment select when the selected augmented reality show data set A2 should be sent to the user data communication device and/or—in case of an optical information—when and/or where the augmented reality data set A2 should appear on the display of the smart device 11. This embodiment is in particular advantageous in case more than one augmented show data sets A2 are selected to correspond to one creator find data set or alternatively to correspond to no information. In case optical information is provided as an augmented reality show data set A2, the creator may predefine the location and/or the time of the appearance of the—and in case of multiple data sets of each—selected augmented reality show data set A2 on the display 112 of the smart device 11. In case audio information is provided as an augmented reality show data set A2, the creator may predefine the time of appearance of the and—in case of multiple augmented reality show data sets A2—of each selected augmented reality data set A2 on the display 112 of the smart device 11.

In an alternative embodiment, the augmented reality content comprises two or more find information data sets, i.e. no information and creator find data set(s) or different creator find data sets, the respective find information data sets may independently from each other correspond to one or more augmented reality show data sets. In this case the creator is required to select a preprogrammed command of the content creating unit whether the different combinations of find information data sets and corresponding augmented reality show data sets shall be performed in a sequential or random order. For example, in case certain pictures at an art exhibition, in particular in a gallery or museum, represent different find information data sets corresponding to one or more augmented reality show data sets respectively, the creator may preferably choose to select randomly performance of the augmented reality content. This selection enables the user to experience the augmented reality content corresponding to the separate pictures in his own order. Alternatively, in particular for educational purposes experiencing of an augmented reality content in a sequential order may be beneficial in order to increase knowledge building. For gamified or experiential augmented reality content experiences of a user, such as a treasure hunt, team building processes, consumer engagement experiences the augmented reality content may comprise the different combinations of find information data sets with augmented reality show data sets dependent on the aim in a sequential or in a random order.

In a further step the creator may be requested to add executing data for carrying out the content by the user. The internet-based augmented reality content may comprise one or more steps. Accordingly means for accessing the next or the previous step may be added by the creator. Furthermore, the internet-based augmented reality content may comprise links, hyperlinks or other means, which can be activated by the user (call to action). Such links, hyperlinks or other means may comprise links to a website such as of the creator etc., rating means of the internet-based augmented reality content by the user, sharing means to share the internet-based augmented reality content with one or more contacts of the user. In a preferred embodiment, the creator may select when the selected additional data sets C should be sent to the smart device 11 and when and/or where the data shall be displayed. In case optical information is provided as an additional data set C, the creator may predefine the location and/or the time of the appearance of the—and in case of multiple additional data sets of each—selected additional data set on the display 112 of the smart device 11. In case audio information is provided as an additional data set C, the creator may predefine the time of appearance of the—and in case of multiple additional data sets of each—selected additional data set C on the smart device 11.

In case the cloud 12 comprises a previewing unit 129, the creator may preview/pre-experience a simulation of the internet-based augmented reality content in particular with the creator data communication device 10, such as the computer 10.

According to a further preferred alternative or cumulative embodiment of the present invention, the creator may select a template augmented reality content preprogrammed on the content creating unit 112 of the cloud 12. This template comprises one or more creator find data sets A1 including no information and one or more augmented reality show data sets A2. This means, the creator does not have to upload or provide access to respective creator find data sets A1 and augmented reality show data sets A2. Instead the creator selects a preprogrammed template of an augmented reality content preferably from a library comprising one or more templates of preprogrammed augmented reality contents stored on the cloud 12 or accessible by the cloud 12. Upon selection, the content creating unit 121 is configured, i.e. preprogrammed to assign to the augmented reality content template a corresponding internet address, which may be masked by the creator as set out above. In order to personalize the selected augmented reality content template for creator purposes, the creator may select brand names and/or user interaction steps, such as “call to action” links, hyperlinks, as additional data sets.

In a preferred embodiment the content creating unit 121 visualizes the creation steps of the augmented reality content on the display 112 of the computer 10, in particular as a visualized story board, preferably comprising one or more buttons comprising information about a step to be conducted and/or the selection to be taken, one or more text fields into which the creator may enter text information, such as a name of the augmented reality content, a “white labeled” internet address to be assigned to the created augmented reality content, one or more upload fields where the creator can upload the data set or data sets as set out above, one or more link fields in which the creator can enter an internet address, in particular URL-address providing a link to an external database comprising one or more data sets. This visualized storyboard preferably leads the creator visually, preferably step by step through the creation process of selecting one or more creator find data sets A1 and one or more augmented reality show data sets A2, preferably one or more additional data sets C. In other words, the visualized story board enables creators without programming experience/skills to create an internet-based augmented reality content in accordance with the present invention.

The inventive data communication system preferably also allows the creator to manage the self-created augmented reality contents, as the find information data set(s) and augmented reality show data set(s) as well as potential additional data set(s) are stored on or are accessible through the cloud 12. In case the creator logs into (signs in) a creator account the inventive data communication system may be configured that the uploaded or accessible data sets may be privately—i.e. third party smart devices 11 without login data are excluded—sorted and/or searched, one or more data sets may be reused or cross-used for other augmented reality contents. This content management system eliminates the necessity of uploading again the same data set(s) already used for other augmented reality contents.

In addition, the content creating unit 121 may comprise one or more publicly accessible data sets stored in a public library of the content creating unit 121, in particular creator find data sets A1, augmented reality show data sets A2, and additional data sets C as set out above, e.g. commands for “go to previous step”, “go to next step”, “save”). These publicly available data sets may be searchable and/or sortable.

The aforementioned steps can be executed in the presented order or in any other suitable order.

In a further step the cloud 12 assigns an internet link, such as a URL address for the created content. The creator may also add a specific name, which can be used to assign the URL address. The internet link is preferably sent to the computer 10.

In a further step the creator may be requested to agree to publish the content.

Alternatively, the creator may save the content and may edit and/or delete the content at a later stage.

As an example, the inventive data communication system 1 in particular allows the following operating processes for exercising and experiencing the internet-based augmented reality content:

The internet link of the internet-based augmented reality content is shared by the creator or any other means with potential users. The creator may share the assigned internet link corresponding to the created augmented reality content by forwarding the internet link with any suitable digital or analogue communication system such as mail, catalogue, email, Facebook, twitter, WhatsApp etc. Sharing the assigned internet link corresponding to the created augmented reality content in accordance with the present invention in particular on social media, such as Facebook, twitter, WhatsApp, does not mean that a software application had to be developed with a software development kit (SDK) for the social media. Instead only the link or hyperlink for the internet address is provided so that the user accesses the inventive platform via the assigned internet-address. Alternatively, the assigned internet link may be coded, such as in form of a QR code or a bar code and may be placed on items, prints etc., or may be provided as a hyperlink on another web page.

A potential user accesses the internet address of the internet-based augmented reality content on the cloud 12 with a suitable browser of the smart device 11. The information about the content is displayed on the respective display of the smart device 11.

In a further step, the cloud 12 sends or provides access to information to the smart device 11 advising which actions are to be executed by the user.

In case the creator find data set A1 is represented by an image, the cloud 12 sends or provides access to information to the smart device 11 that an image shall be taken by the camera unit which represents the sensor data set B. In case creator find data set A1 is (also) represented by an audio information, the cloud 12 sends or provides access to information to the smart device 11 that an audio information shall be recorded by the microphone which represents the sensor data set B. In case the creator find data set A1 is (also) represented by a geolocation information, the cloud 12 sends or provides access to information to the smart device 11 that a geolocation information shall be taken with the GPS unit which represents the sensor data set B. In case the creator find data set A1 is (also) represented by a face recognition unit, the cloud 12 sends or provides access to information to the smart device 11 that a face recognition unit of the smart device 11 shall detect a face which represents the sensor data set B.

In a further step, either the smart device 11 sends or provides access to the sensor data set B to the cloud 12 or the cloud 12 accesses sensor data set B on the smart device 11. The logic unit 121 of the cloud 12 compares the sensor data set B with the creator find data set A1. In case the sensor data set B and the creator find data set A1 match, i.e. have a predetermined degree of conformity, the cloud 12 sends or provides access to the augmented reality show data set A2 to the smart device 12 for experiencing the augmented reality content. The augmented reality show data set A2 is combined with a sensor data set C representing part of the reality. The combination of augmented reality show data set A2 and sensor data set C can be conducted on the smart device 11 or on the cloud 12. In the latter case the sensor data set A2 is sent by the smart device 11 to the cloud 12 for executing the combination of sensor data set C and augmented reality data set A2, wherein the combination is subsequently sent from the cloud 12 to the smart device 11.

As an example, the augmented reality show data A2 is represented by an image of a “red rose” and the sensor data set C is an image or an image sequence (video) of part of reality, such as an image of a “desk”. The “red rose” is combined with the visual information of the “desk”. The user experiences the internet-based augmented reality content as an overlay of a “red rose” on an image or an image sequence of part of reality.

According to a specialized aspect of the present invention, the cloud 12 comprises a user tracking unit 124 and a content analytics unit 125. In this case, the creator is enabled to learn from the user experience information and to improve contents accordingly. Accordingly, the user tracking unit 124 accesses the smart device 11 and logs certain information, in particular the number and/or duration of the execution of the internet-based augmented reality content by the smart device 11, the executed steps of the internet-based augmented reality content by the smart device 11, the smart device 11 details, the geolocation data of the smart devicell and/or the sensor data set B and/or C. The content analytics unit 125 analyzes the logged data from the user tracking unit 124 and provides the analyzed logged statistics data to the computer 10, wherein the analyzed logged statistics data preferably comprises i) a total number of user data communication devices 11 accessing the internet-based augmented reality content (total content visitors), ii) a total number of experiences (views) of the internet-based augmented reality content (total content viewers), iii) a total number of unique experiences (views) of the internet-based augmented reality content per user data communication devices 11 (total number of unique views), iv) an average number of unique experiences (views) of the internet-based augmented reality content per user data communication device 11 respectively (average unique views), v) a total number of interactions between the user data communication devices 11 and the augmented reality show data A2 (total content interactions), vi) a number of unique interactions between the user data communication devices 11 and the augmented reality show data A2 (unique interactions), vii) an average number of unique interactions between a user data communication device 11 and the augmented reality show data A2 respectively (average unique interactions), viii) a number of experiences (views) per step of the internet-based augmented reality content (total views per step), ix) a number of unique experiences (views) per step of the internet-based augmented reality content by the data communication devices 11 (unique views per step), x) an average number of unique experiences (views) per step of the internet-based augmented reality content by the data communication devices 11 (average unique views per step), xi) a number of total activations of links, hyperlinks or other means of the internet-based augmented reality content (total call to action clicks), xii) a number of unique activations of links, hyperlinks or other means of the internet-based augmented reality content by the data communication devices 11 (unique call to actions), xiii) an average number of unique activations of links, hyperlinks or other means of the internet-based augmented reality content per data communication devices 11 (average unique call to actions), xiv) an engagement time between the user data communication devices 11 and the internet-based augmented reality content (total engagement time), xv) an average engagement time between the user data communication devices 11 and the internet-based augmented reality content (average engagement time), xvi) an engagement time per step of the internet-based augmented reality content by the user data communication devices 11 (total engagement time per content step), xvii) an average engagement time per step of the internet-based augmented reality content by the user data communication devices 11 (average engagement time per content step) and/or xviii) a number of user data communication devices 11 accessing the internet-based augmented reality content in real time (real time visitors).

The content analytics unit 125 may be configured, i.e. preprogrammed, to sort the statistical information, in particular by different types of user data communication devices 11, in particular smart devices 11, by different types of internet access units, such as different browsers; and/or by the newest, by ascending or by descending order of access of the internet-based augmented reality content by the user data communication devices 11. The content analytics unit 125 may furthermore be configured, i.e. preprogrammed, to provide the statistical information in form of an excel work-sheet and/or any other means, such as a pdf-document.

This analytical aspect of the present invention is in particular advantageous, as the analyzed logged data is provided to or can be accessed by the creator data communication device 10. The creator thus can access and use the information about the user experience in order to edit the respective internet-based augmented reality content or to improve future internet-based augmented reality contents. In particular, the creator may use the average engagement time per content step to find out which content step may be improved.

According to an alternatively or cumulatively specialized aspect of the present invention, the cloud 12 comprises a deep learning unit 126. In this case, the method of creating the internet-based augmented reality content may be simplified for the creator. Accordingly, the creator may add as creator find data set A1 a general description of a find data, such as a typed or voice recorded term “red rose”. The deep learning unit 126 comprises one or more, preferably 10 or more, more preferably 100 or more, even more preferably 1000 or more find data images A11, which are characterized, in particular tagged with respective keywords characterizing the image, such as “flower”, “rose”, “red” for an image of a “red rose” etc. A logic operator compares the creator find data set A1, such as “red rose”, with the one or more find data images A11. In case the creator find data set A1, such as “red rose”, shows a predetermined conformity with one or more of the find data images A11 those corresponding find data images A111 are assigned to the creator find data set A1 forming the creator find data set A1*. In this case, the sensor data set B is compared with either the corresponding find data images A11 or the assigned creator find data set A1*.

According to an alternatively or cumulatively specialized aspect of the present invention, the cloud 12 comprises an artificial intelligence unit 127 to assist the process of creating the internet-based augmented reality content and/or to assist the process of experiencing the internet-based augmented reality content. In this case, the method of creating or experiencing the internet-based augmented reality content may be simplified for the creator and/or user. Accordingly, the artificial intelligence unit 127 represents a robotic chat box, which provides answers to questions submitted by the creator or the user. The artificial intelligence unit 127 generally comprises one or more suitable logic operators and in particular comprises suitable keywords for creating the internet-based augmented reality content by the creator and/or executing the internet-based augmented reality content by the user. The keywords are assigned with predetermined suitable answers.

According to an alternatively or cumulatively specialized aspect of the present invention, the cloud 12 comprises an augmented reality interaction unit 128. The augmented reality interaction unit 128 generally comprises suitable means, in particular logic operator(s) and is configured, i.e. preprogrammed, to provide interactions between the smart device 11 and the augmented reality show data A2. In other words, the augmented reality interaction unit 128 enables interactions between the smart device 11 and the augmented reality show data A2 in such a way, that a predetermined action executed on the user data communication device 11 triggers a predetermined action of the augmented reality show data A2. As an example, the augmented reality interaction unit 128 accesses the smart device 11 and sends or provides access to an information to the smart device 11 which action needs to be performed by the user in order to interact with a augmented reality show data A2, such as a “ball”. For example, the action “tilting the smart device to the right” will interact with the “ball” by virtually moving the “ball” in the image or image sequence of reality to the right. The action “tilting the smart device to the left” will interact with the “ball” by virtually moving the “ball” in the image or image sequence of reality to the left. The action “contacting the display of the smart device 11 with the finger” will interact with the “ball” by virtually shooting the “ball” into a predetermined direction in the image or image sequence of reality to the right. Suitable sensor units 113, such as acceleration sensors, touch sensors etc. of the smart device 11 send or provides access to the respective action information to the augmented reality unit 128 of the cloud 12 or provide access to the augmented reality unit 128 of the cloud 12. Subsequently, the interaction with the augmented reality show data A2, such as a “ball” is performed. Alternatively, a “red rose” as augmented reality show data A2 may interact with the user by blossoming out in case the user performs a predetermined action. The use of the augmented reality interaction unit 128 is in particular advantageous, as it allows individual experiences of the internet-based augmented reality content by individual users. In case the inventive system 1 comprises the augmented reality interaction unit 128, then the user tracking unit 124 is in particular configured, i.e. preprogrammed, to log the interaction actions executed by the smart device 11 and to provide this information to the computer 10.

According to a cumulative or alternative further aspect of the present invention, the cloud 12 further comprises a previewing unit 129—which when executed by at least one processor—is configured, i.e. preprogrammed, to provide a previewing simulation of the internet-based augmented reality content to the computer 10. In other words, the previewing unit 129 is configured, i.e. preprogrammed, to simulate the internet-based augmented reality content in action prior to publishing the content. According to a preferred aspect, the previewing unit 129 comprises one or more simulation sensor data sets B* and one or more simulation reality data sets C*, wherein the one or more simulation sensor data sets B* and simulation reality data sets C* are tagged with one or more find data set A1 categories. For example, the one or more simulation sensor data sets B* and simulation reality data sets C* may be tagged with categories such as a “geographic location” and provide an image or an image sequence (video) of a geographic location, in particular a corresponding geographic location of the find data set A1. Alternatively or cumulatively, the one or more simulation sensor data sets B* and simulation reality data sets C* may be tagged with “face detection” and provide an image or an image sequence (video) including a face. Further alternatively or cumulatively, the one or more simulation sensor data sets B* and simulation reality data sets C* may be tagged with “image of objects” and may provide an image or an image sequence of objects, wherein preferably the specific objects are additionally tagged, such as “rose”, “chair” etc. Alternatively or cumulatively, the one or more simulation sensor data sets B* and simulation reality data sets C* may be tagged with “audio information” and/or “haptic information” and may provide respective audio and/or haptic information. The previewing unit 129 is further configured, i.e. preprogrammed, to simulate the internet-based augmented reality content in action in form of an image sequence, preferably video with or without audio information, using the tagged simulation sensor data sets B* and C*, which have a predetermined degree of conformity with the find data set A1. As an example, the find data set A1 refers to a geographic location, the previewing unit 129 will select a simulation sensor data set B* and a simulation reality data set C* tagged with “geographic location”, preferably corresponding to the selected geographic location of find data set A1. Alternatively or cumulatively, in case the find data set A1 relates to the provision of a face recognition means, a simulation sensor data set B* and a simulation reality data set C* will be selected which are (additionally) tagged with “face detection”. Alternatively or cumulatively, in case the find data set A1 relates to an image of an object, in particular a specified object, a simulation sensor data set B* and a simulation reality data set C* will be selected which are (additionally) tagged with “image of object”, preferably an image or image sequence of the corresponding specified object. Alternatively or cumulatively, in case the find data set A1 relates to provide an audio or haptic information, then a simulation sensor data set B* and a simulation reality data set C* will be selected which will (additionally) tagged with “audio information” and/or “haptic information”.

In general the inventive platform is in particular suitable for business companies which want to interact with other businesses (B) or individuals (C), such as consumers, clients, skilled persons, patients, staff, etc. Accordingly, the present invention is aimed for B2B or B2C interactions. The following use cases (application methods) of the inventive platform are provided as examples only without limiting the industrial application of the inventive platform to the industrial field of art, e.g. literature, visual art, industrial design, sound and music, commerce, retail, education, emergency management/search and rescue, video games, medical applications in particular for scientists, physicians and/or patients, spatial immersion and interaction, flight training, military applications, navigation, workplace management, broadcasting, live events, tourism and sightseeing, translation, maintenance and/or repair services for products or buildings, product operation, and mail delivery.

Medical applications may, e.g., comprise a campaign directed to educate a skilled person, such as a scientist or a physician or a pharmacist etc., where a certain code or image of a medicinal drug or product package works as creator find data set A1 and augmented reality show data set A2 comprises information on the medicinal drug, such as mode of action, contradiction, adverse events, dosing regimen, etc., or on the medicinal product, such as a video of using the medicinal product, such as a blood pressure device, a blood sugar meter, etc.

In case the internet-based augmented reality content (AR campaign) comprises two or more sub-contents of augmented reality, such a campaign is in particular suitable for gamified and/or experiential experiences, such as in campaigns for a treasure hunt, team building processes, consumer engagement, in particular in retail facilities, such as shopping malls, educational processes. The sub-contents may be displayed in a sequential or in a random order, which is predefined by the creator or the content creating unit 121.

A specific example of a consumer engagement augmented experience in retail, such as in a shopping mall could be, that at the entrance or else of the shopping mall, there is located a code for an assigned intent-address of a created augmented reality content, preferably comprising two or more sub-contents. For example the first augmented reality show data set A1 is pushed to the smart device 11 of a user without any trigger information. The first augmented reality show data set A1 may provide a question to the user, such as find the best store to shop for denim. Either the image of at least part of the store or the geolocation of the store may serve as a the next creator find data set A1 which upon verified matching with a sensor data set B information of the smart device 11 triggers that the next augmented reality show data set A2, such as a coupon with a certain percent of discount is pushed to the smart device 11. Alternatively, in case the user does not wish to shop for denim, the user may also be enabled to skip this augmented reality sub-content and may be forwarded to a further augmented reality sub-content. There he may be asked to search for the best place to relax with a coffee, where again an image of at least part of the store or the geological information would serve as next creator find data set A1. In case the user can provide matching sensor data set B information, the next augmented reality show data set A2, such as again a discount coupon or information on the coffee beans of the week, is pushed by the cloud 12 to the user smart device 12.

For educational use, the inventive augmented reality creating and experiencing platform may be used to build learning experiences step by step, i.e. having multiple augmented reality sub-contents. Here, for example, it may be beneficial that the augmented reality sub-contents may be performed in a sequential order to make sure that relevant knowledge is provided before another which relates thereto.

Alternatively, the inventive augmented reality content may be applied to maintenance and/or repairing services. For example in a smart home, the pipelines and/or electrical lines in walls, floors and/or ceilings may be digitalized and used as augmented reality show data sets A2, whereas geological position information may serve as creator find data set A1. In case of construction works a worker will access the assigned internet address and will be asked to direct the smart device 11 to the respective walls, floors and/or ceilings, where construction work shall take place. The sensor data set B comprising geological information and positioning information of the smart device 11 will be used to be compared with the creator find data set A1. In case the logic unit of the inventive system confirms the matching of the data sets, e.g. an image of the pipelines and/or electrical lines within the wall, floor or ceiling will be pushed to the smart device 11 so that the worker can either directly identify where to repair the pipeline or, where not to open the wall, floor or ceiling.

According to another alternative application method the inventive augmented reality platform may enable a remote guidance for example of product maintenance or repair. In case an employee shall perform maintenance and/or repair services in a remote area, the supervisor may use as a creator the inventive platform in order to communicate with the employee in a predefined way. For example, the supervisor may choose the motor of a car as creator find data set A1 and uploads the information from a computer 10 to the cloud 12 and may further choose augmented reality show data set(s) A2 and uploads it to the cloud 12 with the computer 10. The smart device 11 of the employee upon accessing the assigned internet address to the augmented reality content, may be asked to place the smart device 11 in such a way that the motor of a car can be visualized. A respective sensor data set B will be sent to the cloud 12 and upon comparison and confirmed conformity by the logic unit 122, the cloud 12 may push the augmented reality show data set A2 to the smart device 11. The augmented reality show data set A2 may comprise one or more information, such as information on the item to be exchanged, repaired, etc. and/or information on how to exchange or repair the item. Interaction of the employee and the supervisor may also be enabled by the inventive augmented reality content through respective interaction modules, such as input fields for the employee to define questions etc. This information provided by the employees' smart device is uploaded to the cloud 12 and is preferably accessible to the computer 10 of the supervisor. He then may edit the augmented reality content and provide a further augmented reality show data set A2 to be pushed from the cloud to the smart device 11 of the employee.

Another alternative application method relates to product operation guides, in particular of products, machines, cars etc. In particular in case the products, machines, cars etc. provide information in a language unknown to a user this inventive method is beneficial, as alphanumerical/character information of the product or any warning information, such as a red lamp, could serve as a creator find data set in form of an image or a geological position etc. which upon comparison with sensor data set B of the smart device 11 of the user and determined matching by the logic unit 122, triggers sending the augmented reality show data set A2 from the cloud to the smart device 11. The augmented reality show data set A2 may comprise information on how to operate the product, machine, car, in particular dish washer, washing machine, coffee maker, water boiler for hot water, etc. in particular which meaning has the alphanumerical/characters or warning information.

Another alternative application method may relate to the field of delivery services, such as mail delivery, courier delivery. In a simple embodiment, the content of a mail/delivery item may be photographed by a sender, which acts as a creator in view of the inventive platform. The photograph of the content, such as a product ordered online, may serve as augmented reality show data set A2. Alternatively or in addition, the augmented reality show data set A2 may comprise information on the weight, dimensions, handling conditions (cooled storage, careful handling because of glass items etc) and so on of the mailed/delivered envelope/package. Furthermore, the mail or delivery item (envelope, package, etc.) may be photographed from the outside, e.g. including the address field and/or comprising the order number, which may serve as creator find data set A1. According to a simple embodiment, the data sets A1 and A2 are uploaded from the computer 10 to the cloud 12 and stored thereon. The content creating unit 121 assigns an internet address to the augmented reality content and makes this internet address as such or in form of a code, such as a QR code available to the sender (creator) computer 10. The sender (creator) may be share this assigned internet address or code thereof as a print on the mail/delivery item or digital (email, etc.) with relevant user parties, such as the recipient and/or the mail service/delivery service. After the recipient or mail service/delivery service accesses the assigned internet address and photographs the mailed/delivered item, the sensor data B is sent from the smart device 11 to the cloud 12. Upon confirmation of the predetermined degree of conformity by the logic unit 122, cloud 12 pushes the augmented reality show data set A2 to the smart device 11 so that the recipient or mail service/delivery service and experience the augmented reality information.

The above description of the present invention is provided to enable the skilled person to make or use the invention. It should be noted that the foregoing description is only illustrative of the invention. Various modifications to these embodiments can be devised by those skilled in the art without departing of the present invention. Accordingly, the present invention is intended to embrace all such alternatives, modifications and variances which fall within the scope of the disclosed invention.

1. A data communication system for creating and/or experiencing an internet-based augmented reality content comprising a creator data communication device to be used by a creator, a user data communication device to be used by a user and an internet-based data processing device, wherein
a) the creator data communication device comprises an internet access unit with an application programming interface (API) for the internet-based data processing device, a display unit for displaying information, a processing unit comprising one or more processors, and an input unit for inputting a data set (A) for creating the internet-based augmented reality content, wherein the data set (A) comprises optionally a creator find data set (A1) and comprises an augmented reality show data set (A2), wherein the creator data communication device—which when executed by at least one processor—is configured to send or to provide access to the data set (A) to the internet-based data processing device,
b) the user data communication device comprises an internet access unit with an application programming interface (API) for the internet-based data processing device, a display unit for displaying information, one or more sensor units, and a processing unit comprising one or more processors, wherein the user data communication device—which when executed by at least one processor—is configured to send or to provide access to a sensor data set (B) obtained from the one or more sensor units to the internet-based data processing device and to retrieve the augmented reality show data set (A2) from the internet-based data processing device for experiencing the internet-based augmented reality content on the user data communication device, and
c) the internet-based data processing device comprises a content creating unit, a logic unit and a processing unit comprising one or more processors, wherein the internet-based data processing device—which when executed by at least one processor—is configured to store the data set (A) and create the internet-based augmented reality content in the content creating unit, wherein content creating unit is configured to assign an internet address, preferably a URL address, to the internet-based augmented reality content and to send or to provide access to the assigned internet address to the creator data communication device and/or to make publicly available the assigned internet address, and the internet-based data processing device is further configured to compare the sensor data set (B) received or accessed from the user data communication device with the creator find data set (A1) for a predetermined degree of conformity and to send or to provide access to the augmented reality show data set (A2) to the user data communication device in case the sensor data set (B) and the creator find data set (A1) match.

2. The data communication system according to claim 1, wherein the creator data communication device is in the form of one or more separate devices and is independently from each other selected from the group consisting of a desktop computer, a laptop computer, a mobile smart device, in particular a smart phone, a smart tablet and a smart wearable, such as smart watch, smart glasses and smart gloves.

3. The data communication system according to claim 1, wherein the creator find data set (A1) is selected from the group consisting of an optical information, preferably an alphanumeric information, a code information, such as a bar code or a Quick Read (QR) code, an image, preferably an image view of a portion of reality and an image of a face, an audio information, a geolocation information and/or a haptic information.

4. The data communication system according to claim 1, wherein the augmented reality show data set (A2) is selected from the group consisting of an optical information, preferably an image, a video, a three dimensional (3D) image, text information, html5 information, e.g. in form of a web page, a game, and a survey, and a two or a three dimensional (3D) animation, an audio information, and/or a haptic information.

5. The data communication system according to claim 1, wherein the user data communication device is in the form of one or more separate devices and is independently from each other selected from the group consisting of a laptop computer, a mobile smart device, in particular a smart phone, a smart tablet and a smart wearable, such as a smart watch, smart glasses and smart gloves.

6. The data communication system according to claim 1, wherein the one or more sensor units are selected from the group consisting of an optical sensor unit, preferably a camera unit, an audio sensor unit, preferably a microphone, a geolocation sensor unit, preferably a GPS unit, and a haptic sensor unit.

7. The data communication system according to claim 1, wherein the internet-based data processing device comprises an internet-based server network, preferably a cloud server network.

8. The data communication system according to claim 1, wherein the internet-based data processing device further comprises
a user tracking unit—which when executed by at least one processor—is configured to log the one or more user data communication device details and/or to log statistic information about interaction between the one or more user data communication devices and the internet-based augmented reality content, and
a content analytics unit—which when executed by at least one processor—is configured to statistically analyze the logged data from the user tracking unit and to provide the analyzed logged statistics data to the creator data communication device.

9. The data communication system according to claim 1, wherein the internet-based data processing device further comprises
a deep learning unit comprising one or more find data images (A11)—which when executed by at least one processor—is configured to match the creator find data set (A1) with one or more corresponding find data images (A111), and to compare the corresponding find data images (A111) with the sensor data set (B) and/or
an artificial intelligence unit—which when executed by at least one processor—is configured to assist the process of creating the internet-based augmented reality content and/or to assist the process of experiencing the internet-based augmented reality content, and/or
an augmented reality interaction unit—which when executed by at least one processor—is configured to provide interactions between the user data communication device and the augmented reality show data (A2), and/or
a previewing unit—which when executed by at least one processor—is configured to provide a previewing simulation of the internet-based augmented reality content to the creator data communication device.

10. A method for creating an internet-based augmented reality content using a data communication system of claim 1, wherein the method comprises the following steps:
d) Providing an internet-based data processing device comprising a content creating unit, a logic unit and a processing unit comprising one or more processors,
e) Providing a creator data communication device comprising an internet access unit with an application programming interface (API) for the internet-based data processing device, a display unit for displaying information, a processing unit comprising one or more processors, and an input unit for inputting a data set (A) for creating the internet-based augmented reality content, wherein the data set (A) optionally comprises a creator find data set (A1) and comprises an augmented reality show data set (A2), and accessing the internet-based data processing device,
f) Sending or providing access to the data set (A) optionally comprising the creator find data set (A1) and comprising the augmented reality show data set (A2) from the creator data communication device to the internet-based data processing device,
g) Creating the internet-based augmented reality content with the content creating unit, and
h) Assigning an internet address, preferably a URL address to the internet-based augmented reality content by the internet-based data communication device and sending or providing access to the assigned internet address of the internet-based augmented reality content to the creator data communication device and/or making publicly available the assigned internet address of the internet-based augmented reality content.

11. The method according to claim 10, wherein the internet-based data processing device further comprises a deep learning unit comprising or having access to one or more find data images (A11), wherein in step d) the internet-based augmented reality content is created with the content creating unit and the deep learning unit, wherein the creator find data set (A1) is compared with the one or more find data images (A11) and in case one or more corresponding find data images (A111) match with the creator find data set (A1) at least part, preferably all corresponding find data images (A111) are assigned to the creator find data set (A1*).

12. The method according to claim 10, wherein the internet-based data processing device further comprises an artificial intelligence unit, wherein in step d) the creating of the internet-based augmented reality content is assisted by the artificial intelligence unit.

13. The method according to claim 1, wherein the internet-based data processing device further comprises a previewing unit, wherein in step d) a previewing simulation of the internet-based augmented reality content is provided to or can be accessed by the creator data communication device.

14.The method for experiencing an internet-based augmented reality content using a data communication system of claim 1, wherein the method comprises the following steps:
i) Providing an internet-based data processing device comprising a content creating unit and a stored internet-based augmented reality content comprising a data set (A) with optionally a creator find data set (A1) and with an augmented reality show data set (A2), a logic unit and a processing unit comprising one or more processors,
j) Assigning an internet address, preferably a URL address, to the stored internet-based augmented reality content of step a),
k) Providing a user data communication device comprising an internet access unit with an application programming interface (API) for the internet-based data processing device, a display unit for displaying information, one or more sensor units, and a processing unit comprising one or more processors, and accessing the internet-based data processing device by use of the assigned internet address of step b),
l) Optionally recording a sensor data set (B) with the one or more sensor units and sending or providing access to the sensor data set (B) to the internet-based data processing device,
m) Optionally comparing the sensor data set (B) with the creator find data set (A1) for a predetermined degree of conformity by use of the logic unit and sending or providing access to the augmented reality show data set (A2) from the internet-based data processing device to the user data communication device in case the sensor data set (B) and the creator find data set (A1) match or sending or providing access to the augmented reality show data set (A2) from the internet-based data processing device to the user data communication device after accessing the internet-based data processing device by the user data communication device, and
n) Experiencing the internet-based augmented reality content on the user data communication device by adding the augmented reality show data set (A2) to a reality data set (C) recorded by one or more of the sensor units and displaying the combination thereof.

15. The method according to claim 14, wherein the internet-based data processing device further comprises a user tracking unit and a content analytics unit, wherein the method comprises or consists of the following steps:
g) Tracking the user data communication device with the user tracking unit of the internet-based data processing device thereby logging the number and/or duration of the execution of the internet-based augmented reality content by the user data communication device, logging the executed steps of the internet-based augmented reality content by the user data communication device, logging user data communication device details, logging geolocation data of the user data communication device and/or logging the sensor data set (B),
h) Providing a creator data communication device comprising an internet access unit with an application programming interface (API) for the internet-based data processing device, a display unit for displaying information, a processing unit comprising one or more processors, and an input unit for inputting a data set (A) for creating the internet-based augmented reality content and accessing the internet-based data processing device, and
i) Analyzing the logged data from the user tracking unit with the content analytics unit, and sending or providing access to the analyzed logged data to the creator data communication device, wherein the analyzed logged data preferably comprises i) a total number of executions of the augmented reality content, ii) a total number of user data communication devices executing the augmented reality content, iii) an average execution number of augmented reality content per user data communication device, iv) an average duration of the augmented reality content execution, and/or v) the user data communication device details, in particular the user data communication device location data.

16. The method according to claim 14, wherein the internet-based data processing device further comprises a deep learning unit comprising one or more find data images (A11), wherein in step a) a creator find data set (A1*) is provided, which comprises the creator find data set (A1) and one or more corresponding find data images (A111) assigned thereto, wherein the corresponding find data images (A111) match with the creator find data set (A1), and in step e) the sensor data set (B) is compared with the one or more corresponding find data images (A111) or the creator find data set (A1*) and the augmented reality show data set (A2) is sent from the internet-based data processing device to the user data communication device in case the sensor data set (B) and the corresponding find data images (A111) or the creator find data set (A1*) match.

17. The method according to claim 14, wherein the internet-based data processing device further comprises an artificial intelligence unit, wherein the method for experiencing the internet-based augmented reality content is assisted by the artificial intelligence unit.

18. (canceled)

19. The method according to claim 10, wherein the internet-based augmented reality content is in the industrial field of art, e.g. literature, visual art, industrial design, sound and music, commerce, retail, education, emergency management/search and rescue, video games, medical applications in particular for scientists, physicians and/or patients, spatial immersion and interaction, flight training, military applications, navigation, workplace management, broadcasting, live events, tourism and sightseeing, translation, maintenance and/or repair services for products or buildings, product operation, and mail delivery.

20. The method according to claim 14, wherein the internet-based augmented reality content is in the industrial field of art, e.g. literature, visual art, industrial design, sound and music, commerce, retail, education, emergency management/search and rescue, video games, medical applications in particular for scientists, physicians and/or patients, spatial immersion and interaction, flight training, military applications, navigation, workplace management, broadcasting, live events, tourism and sightseeing, translation, maintenance and/or repair services for products or buildings, product operation, and mail delivery.
